(19) United States
(12) Patent Application Publication
(10) Pub. No.: US 2008/0049128 A1
(43) Pub. Date: Feb. 28, 2008

(54) Solid-state device for high-speed photographing and camera provided with the solid-state imaging device as imaging device

(76) Inventors: Takahiko Murata, Osaka (JP); Takumi Yamaguchi, Kyoto (JP); Shigetaka Kasuga, Osaka (JP); Takayoshi Yamada, Osaka (JP)

Correspondence Address: MCDERMOTT WILL & EMERY LLP, 600 13TH STREET, NW, WASHINGTON, DC, 20005-3096, US

(21) Appl. No.: 11/889,209

(22) Filed: Aug. 9, 2007

(30) Foreign Application Priority Data
Aug. 10, 2006 (JP) 2006-218254

(51) Int. Cl. H04N 3/14

(52) U.S. Cl. 348/294

(57) ABSTRACT

In each pixel of a MOS-type solid-state imaging device, a plurality of first signals and one or more second signals are accumulated in a plurality of storage areas in a storage unit during driving. Here, each of the plurality of first signals corresponds to a light receiving signal (light receiving signal on which noise is superimposed) which is transmitted from a light receiving unit each time a switching unit is in a closed state, and each of the one or more second signals is a signal (noise such as dark-current noise, fixed pattern noise, and the like) as a voltage of a signal readout path when the switching unit is in an open state. Also, in the solid-state imaging device of the present invention, each of the one or more second signals in the storage unit of each image pixel is in a state of being physically or temporally separated from each of the plurality of first signals.

### BACKGROUND OF THE INVENTION

(1) Field of the Invention

The present invention relates to a solid-state imaging device for high-speed photographing and a camera provided with the solid-state imaging device as an imaging device.

(2) Related Art

A camera for high-speed photographing is used for analyses of (a) a vehicle crash test, (b) a drop test and a strength test of a product, (c) a combustion state of an internal-combustion engine, (d) a phenomenon in a physicochemical field such as a chemical reaction, and the like. The following describes a structure example of a solid-state imaging device which is adopted as an imaging device of a camera for high-speed photographing, with reference to FIG. 1. FIG. 1 is a partial plan view showing a part of a structure of a CCD-type solid-state imaging device proposed in Japanese Published Patent Application No. 2000-165750 (hereinafter, referred to as a “patent document”).

As shown in FIG. 1, in the CCD-type solid-state imaging device of the patent document, a plurality of photodiodes 930a are arranged in a matrix at a predetermined interval with each other. On an upper side in a Y-axis direction of each photodiode 930a, a charge collection well 931a and an input gate 932a are arranged (refer to an upper-right enlarged part in FIG. 1).

Also, in the CCD-type solid-state imaging device of the patent document, a CCD transfer path 933a is formed so as to be in an oblique direction to both an X-axis and the Y-axis. In other words, the CCD transfer path 933a is arranged in an oblique direction to a virtual line 940 which connects the input gate 932a and an input gate 932b lined in the Y-axis direction. On a lower-left side of the CCD transfer path 933a which is an other edge, a drain gate 935a and a drain 936a are arranged (refer to an lower-right enlarged part in FIG. 1).

When driving the CCD-type solid-state imaging device of the patent document, image information (a light receiving signal charge) generated in the photodiode 930a is collected in the charge collection well 931a, and the collected light receiving signal charge is transferred to the CCD transfer path 933a via the input gate 932a. The light receiving signal charge is passed through the CCD transfer path 933a, and transferred to the drain 936a via the drain gate 935a on the lower-left side. This CCD-type solid-state imaging device executes the standard three-phase drive.

In the CCD-type solid-state imaging device which adopts the above-mentioned structure, the CCD transfer path 933a includes a plurality of charge storage elements. As a result, when writing an image, high-speed photographing can be realized by writing the image in the charge storage elements in the CCD transfer path 933a.

Note that in the CCD-type solid-state imaging device of the patent document, the CCD transfer path 933a is formed so as to be linearly extended toward a lower-left side for a distance corresponding to 6 pixels. Therefore, a CCD transfer path 933b which leads to the input gate 932b and is arranged on a lower side in the Y-axis direction can be incorporated in a light receiving surface.

However, the CCD-type solid-state imaging device of the patent document has a problem that a large amount of electric power consumption is required. That is to say, in order to realize high-speed photographing, the above-mentioned CCD-type solid-state imaging device adopts the structure that is a normal device structure to which the CCD transfer paths 933a and 933b for accumulating image signals are added. However, a voltage pulse in a range of 9 [V] to 12 [V] inclusive is required to be applied when a charge is transferred to a CCD. Therefore, the above-mentioned CCD-type solid-state imaging device consumes a large amount of electric power for a transfer drive.

### SUMMARY OF THE INVENTION

In view of this, an object of the present invention is to provide a solid-state imaging device which is capable of realizing high-speed photographing while high image quality is maintained and suppressing an increase of electric power consumption for driving, and a camera provided with the solid-state imaging device as an imaging device.

To fulfill the above object, the solid-state imaging device of the present invention has the following structure.

The solid-state imaging device of the present invention includes an image area that is composed of a plurality of image pixels, and comprises a light receiving unit, a storage unit, and a switching unit. The light receiving unit is formed in the image area in correspondence with each of the plurality of image pixels, and generates a light receiving signal corresponding to an intensity of received light. The storage unit is arranged in correspondence with each of the plurality of image pixels, and includes a plurality of storage areas.

The switching unit that has one end connected to the light receiving unit, and an other end connected to the storage unit via a signal readout path (path of the light receiving signal). Also, the switching unit repeats an opening and closing operation during driving, and a plurality of first signals and one or more second signals are accumulated in the plurality of storage areas in the storage unit. Here, each of the plurality of first signals corresponds to the light receiving signal that is transmitted from the light receiving unit each time the switching unit is in a closed state (light receiving signal on which noise is superimposed), and each of the one or more second signals is a voltage of the signal readout path when the switching unit is in an open state (noise such as dark-current noise, fixed pattern noise, and the like).

Also, each of the one or more second signals in the storage unit is in a state of being physically or temporally separated from each of the plurality of first signals. Here, “in a state of being physically separated” means that the plurality of first signals and the one or more second signals are accumulated in different storage areas, or each of the plurality of first signals is accumulated in a different storage area. On the other hand, “in a state of being temporally separated from each other” means that the plurality of first signals and the one or more second signals are accumulated in one storage area in a time division, or each of the plurality of first signals is accumulated in one storage area in a time division.

As mentioned above, in the solid-state imaging device of the present invention, the plurality of first signals are accumulated in the plurality of storage areas in the storage unit in time series. Therefore, the solid-state imaging device of the present invention is suitable for high-speed photographing. Also, in the solid-state imaging device of the present invention, the plurality of first signals can be accumulated in time series by the opening and closing operation by the switching unit. Therefore, the solid-state imaging device of the present invention is capable of realizing high-speed photographing while trying to reduce electric power consumption, compared to the CCD-type solid-state imaging device of the patent document which sequentially accumulates signals in a CCD (Charge Coupled Device). In other words, in a conventional CCD-type solid-state imaging device, a high-voltage pulse in a range of 9 [V] to 12 [V] inclusive is required to transfer charges to a plurality of CCDs. As a result, a large amount of electric power is consumed to accumulate a plurality of signals. On the other hand, in the solid-state imaging device of the present invention, the switching unit repeats the opening and closing operation, and the plurality of first signals are accumulated in the storage unit in time series each time the switching unit is in the closed state. Therefore, high-speed photographing can be realized only by executing the opening and closing operation by the switching unit, without executing the transfer operation by the CCD-type solid-state imaging device of the patent document, and an increase of electric power consumption can be suppressed.

Moreover, the solid-state imaging device of the present invention adopts the structure in which each of the one or more second signals which is a voltage (noise) of the signal readout path is accumulated in the storage unit. Therefore, a high quality image with less noise can be obtained by performing the process of obtaining the difference between each of the plurality of first signals (light receiving signal+noise) and each of the one or more second signals (noise).

Thus, in the solid-state imaging device of the present invention, high-speed photographing can be realized while high image quality is maintained, and an increase of electric power consumption for driving can be suppressed.

Since a camera of the present invention has the solid-state imaging device of the present invention, the camera can obtain the same effect.

The following are variations of the solid-state imaging device of the present invention.

The solid-state imaging device of the present invention can adopt a construction in which the storage unit is connected to one end of a signal transmission path that transmits the plurality of first signals and the one or more second signals, and a difference circuit unit that obtains a difference between each of the plurality of first signals and each of the one or more second signals is connected to an other end of the signal transmission path. With the above-stated construction, high-speed photographing can be realized and high image quality performance can be assured.

The solid-state imaging device of the present invention can adopt a construction in which each of the plurality of storage areas in the storage unit has a capacitor, and the signal readout path and the signal transmission path are connected to one pole of each of a plurality of capacitors. With the above-stated construction, the solid-state imaging device of the present invention having the above-mentioned advantage can be realized by the simple circuit structure in which the plurality of capacitors are arranged in parallel between the signal readout path and the signal transmission path, i.e. between the light receiving unit and the output circuit.

Also, the solid-state imaging device of the present invention can adopt a construction in which each of the plurality of storage areas in the storage unit has a capacitor, and the signal readout path is connected to one pole of each of a plurality of capacitors, and the signal transmission path is connected to an other pole of each of the plurality of capacitors. With the above-stated construction, the plurality of capacitors are arranged in series between the light receiving unit and the output circuit. However, the solid-state imaging device of the present invention having the above-mentioned advantage can be realized by the simple circuit structure same as in the above-mentioned parallel structure.

Note that the solid-state imaging device of the present invention can adopt a construction in which a selecting unit that switches connection/disconnection between the storage unit and the difference circuit unit is provided in the signal transmission path. With the above-stated construction, the plurality of first signals and the one or more second signals can be transmitted in a state of being certainly separated from each other.

The solid-state imaging device of the present invention can adopt a construction in which a number of the second signals is same as a number of the plurality of first signals, the plurality of storage areas are divided into two groups, each includes a same number of storage areas, the plurality of first signals are accumulated in one of the two groups, and the plurality of second signals are accumulated in the other group, and one of the storage areas in which each of the plurality of first signals is accumulated and one of the storage areas in which each of the plurality of second signals is accumulated make a pair. With the above-stated construction, when a total of n (n≧2) storage areas are formed, a difference between each of the plurality of first signals and each of the plurality of second signals is an output signal. Therefore, high-speed photographing of (n/2) frames can be realized, and a high quality image with less noise can be outputted.

The solid-state imaging device of the present invention can adopt a construction in which the plurality of storage areas are divided into a first group for accumulating the plurality of first signals and a second group for accumulating the one or more second signals, and a number of storage areas included in the second group is one or more, and is smaller than a number of storage areas included in the first group. With the above-stated construction, when the total formation number of the storage areas in the storage unit is n, more frame numbers can be ensured and the solid-state imaging device is more suitable for high-speed photographing, compared to the case in which the number of the storage areas for the plurality of first signals is same as the number of the storage areas for the one or more second signals. Especially when the number of the storage areas for the plurality of first signals is (n−1) and the number of the storage areas for the one or more second signals is 1, high-speed photographing of (n−1) frames can be realized even if the total formation number of the storage areas in the storage unit is n. Therefore, high-speed photographing of more framed can be realized with a relatively compact size.

Moreover, the solid-state imaging device of the present invention can adopt a construction in which each of the one or more second signals in the storage unit is in a state of being temporally separated from each of the plurality of first signals, and each of the one or more second signals is accumulated after each of the plurality of first signals is accumulated and read out during driving. With the above-stated construction, each of the one or more second signals is accumulated in a state of being temporally separated from each of the plurality of first signals. Thus, when the total formation number of the storage areas in the storage unit is n (n≧2), high-speed photographing of n frames which is same as the formation number can be realized. Also, a high quality image signal with less noise can be outputted if a difference between each of the plurality of first signals and each of the one or more second signals is obtained and the difference is outputted as in the above case of temporally dividing the plurality of first signals and the one or more second signals.

Furthermore, the solid-state imaging device of the present invention can adopt a construction in which an amplifying unit that amplifies each of the plurality of first signals and each of the one or more second signals is inserted in the signal readout path.

Also, the solid-state imaging device of the present invention can adopt a construction in which an initializing function unit that initializes a signal accumulation state in each of the plurality of storage areas is connected to the storage unit.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 is a plan view showing apart of a solid-state imaging device for high-speed photographing of a conventional technology;

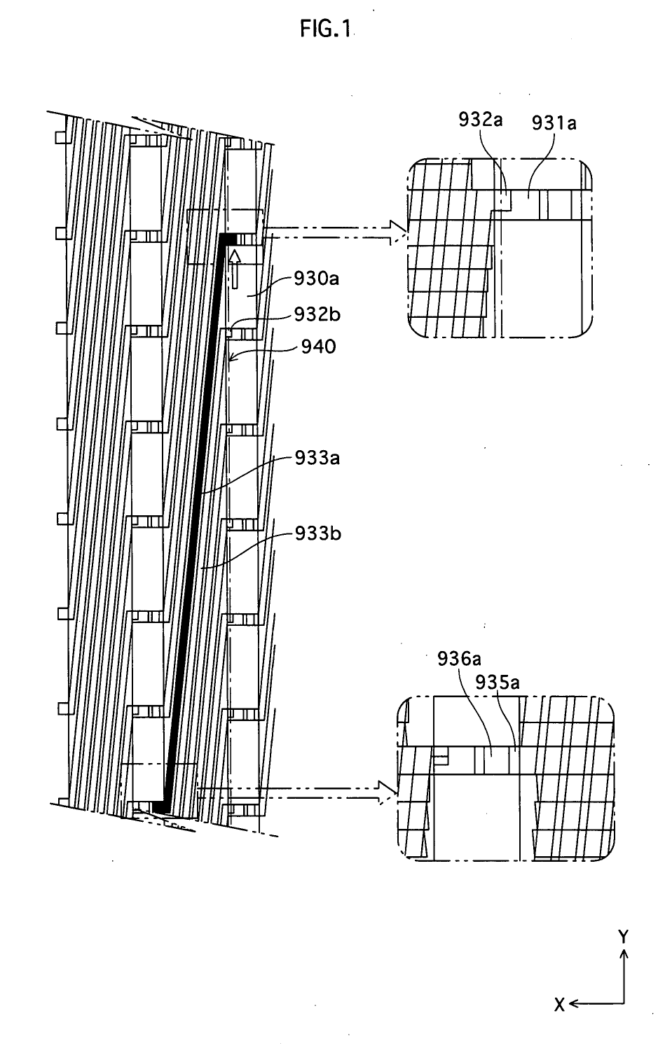

FIG. 2 is a block diagram showing a structure of a camera 1000 of a first embodiment;

FIG. 3 is a functional block diagram showing a structure of a MOS-type solid-state imaging device 100 of the first embodiment;

FIG. 4 is a circuit diagram showing a structure of an image pixel 50 in the MOS-type solid-state imaging device 100;

FIG. 5 is a timing chart showing an applied timing of a signal to each gate of the image pixel 50 when driving the MOS-type solid-state imaging device 100;

FIG. 6 is a circuit diagram showing a structure of an image pixel 150 in a structure of a MOS-type solid-state imaging device of a second embodiment;

FIG. 7 is a timing chart showing an applied timing of a signal to each gate of the image pixel 150 when driving the MOS-type solid-state imaging device of the second embodiment;

FIG. 8 is a circuit diagram showing a structure of an image pixel 250 in a structure of a MOS-type solid-state imaging device of a third embodiment;

FIG. 9 is a timing chart showing an applied timing of a signal to each gate of the image pixel 250 when driving the MOS-type solid-state imaging device of the third embodiment;

FIG. 10 is a circuit diagram showing a structure of an image pixel 350 in a structure of a MOS-type solid-state imaging device of a fourth embodiment;

FIG. 11 is a timing chart showing an applied timing of a signal to each gate of the image pixel 350 when driving the MOS-type solid-state imaging device of the fourth embodiment;

FIG. 12 is a circuit diagram showing a structure of an image pixel 450 in a structure of a MOS-type solid-state imaging device of a fifth embodiment;

FIG. 13 is a timing chart showing an applied timing of a signal to each gate of the image pixel 450 when driving the MOS-type solid-state imaging device of the fifth embodiment;

FIG. 14 is a circuit diagram showing a structure of an image pixel 550 in a structure of a MOS-type solid-state imaging device of a sixth embodiment; and

FIG. 15 is a timing chart showing an applied timing of a signal to each gate of the image pixel 550 when driving the MOS-type solid-state imaging device of the sixth embodiment.

### DESCRIPTION OF THE PREFERRED EMBODIMENTS

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be constructed as being included therein.

The following describes preferred embodiments of the present invention, with reference to two concrete examples. Note that the following embodiments are examples of the present invention, and the present invention is not limited to the following embodiments other than the essential features thereof.

### First Embodiment

### 1. Structure of Camera 1000

A camera 1000 of a first embodiment is a camera for high-speed photographing, which is used for analyses of a vehicle crash test, a drop test and a strength test of a product, a combustion state of an internal-combustion engine, a phenomenon in a physicochemical field such as a chemical reaction, and the like.

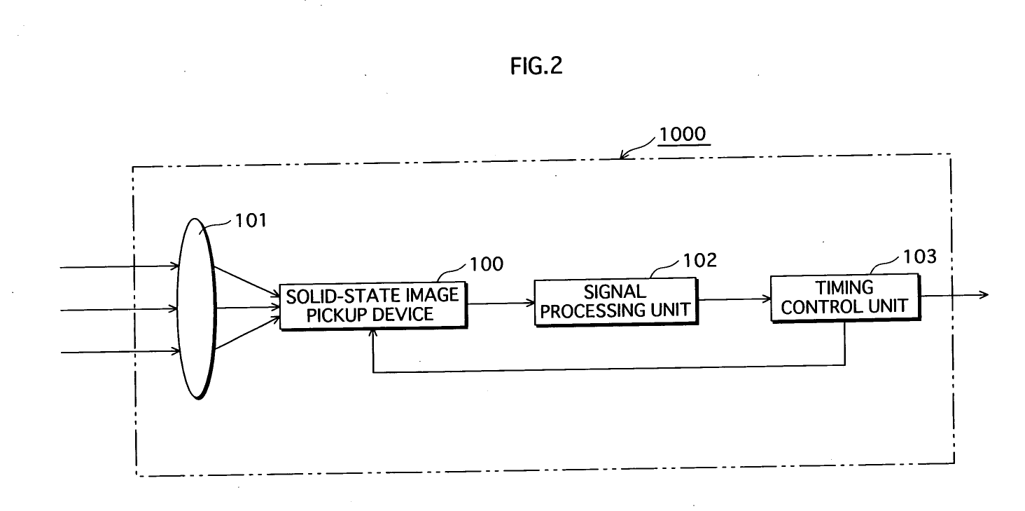

As shown in FIG. 2, the camera 1000 is composed of a MOS-type solid-state imaging device 100, a lens 101, a signal processing unit 102, a timing control unit 103, and the like. The lens 101 is a component for focusing an optic image of an object on the MOS-type solid-state imaging device 100. Note that an optical element for performing an optical process of an optic image such as a mirror, a shutter, and the like (not illustrated) is arranged between the lens 101 and the MOS-type solid-state imaging device 100.

The signal processing unit 102 includes a GCA (Gain Control Amplifier) circuit, an ADC (A-D Converter) circuit, an OBC (Optical Black Clamp) circuit, and the like. The GCA circuit obtains a difference between an OB (Optical Black) level detected in the OBC circuit and a signal level of an effective pixel, and adjusts a gain of the difference.

The ADC circuit converts an analog signal outputted from the GCA circuit to a digital signal.

The timing control unit 103 includes a DSP (Digital Signal Processing) circuit, a TG (Timing Generator) circuit, and the like. The DSP circuit processes the digital signal outputted from the signal processing unit 102, and controls a drive timing. The TG circuit generates various drive pulses to the MOS-type solid-state imaging device 100 at various timings, based on an instruction signal from the DSP circuit.

### 2. Structure of MOS-Type Solid-State Imaging Device 100

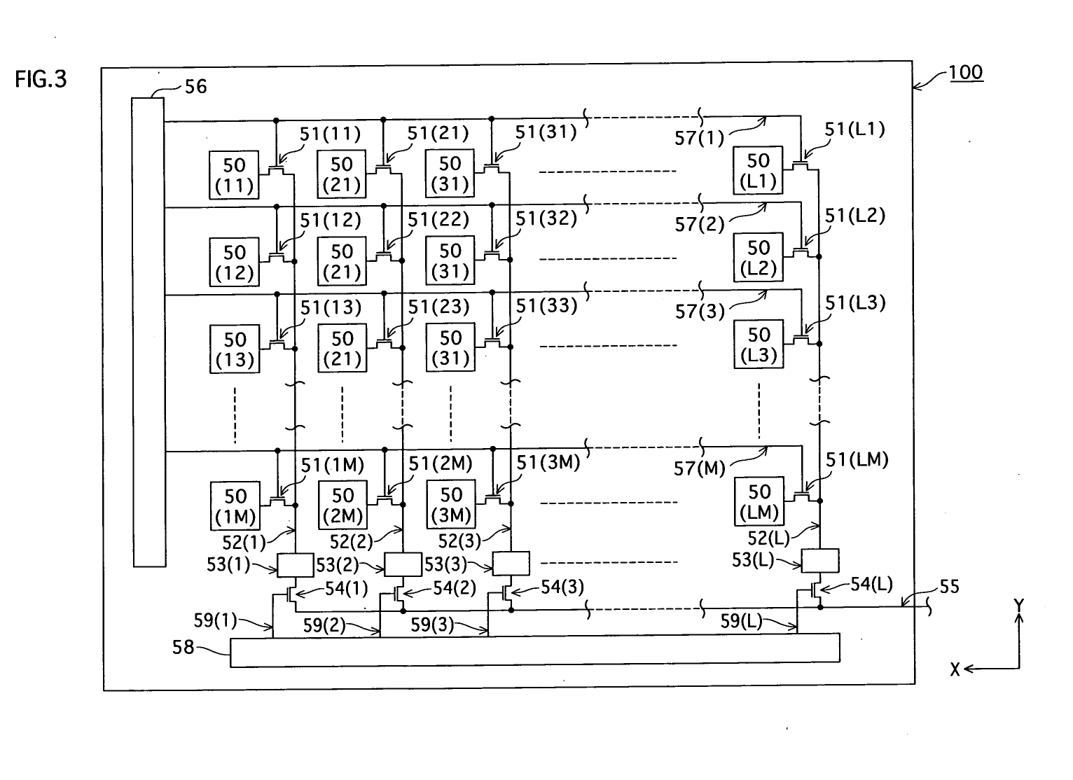

The MOS-type solid-state imaging device 100 of the first embodiment will be described with reference to FIG. 3. FIG. 3 is a functional block diagram showing a structure of the MOS-type solid-state imaging device 100 of the first embodiment.

As shown in FIG. 3, (L×M) image pixels 50 (11) to 50 (LM) are arranged in a matrix in the MOS-type solid-state imaging device 100 of the first embodiment. Output parts of the image pixels 50 (11) to 50 (LM) are connected to MOS transistors 51 (11) to 51 (LM) respectively, and the MOS transistors 51 (11) to 51 (LM) are connected to common vertical signal lines 52 (1) to 52 (L) respectively.

The common vertical signal lines 52 (1) to 52 (L) are connected to noise-canceling circuits 53 (1) to 53 (L) respectively. The noise-canceling circuits 53 (1) to 53 (L) are connected to a common signal line 55 via MOS transistors 54 (1) to 54 (L) respectively.

Also, in the MOS-type solid-state imaging device 100, a vertical scanning circuit 56 and a horizontal scanning circuit 58 are provided in a surrounding part of the (L×M) images pixels 50 (11) to 50 (LM) which are arranged in a matrix. M signal output lines 57 (1) to 57 (L) are extended from the vertical scanning circuit 56 to an X-axis direction, and connection is performed on gates of the MOS transistors 51 (11) to 51 (LM) for each row.

On the other hand, L signal output lines 59 (1) to 59 (L) are extended from the horizontal scanning circuit 58 to a Y-axis direction, and connection is performed on gates of the MOS transistors 54 (1) to 54 (L) for each column.

### 3. Structure of Image Pixel 50

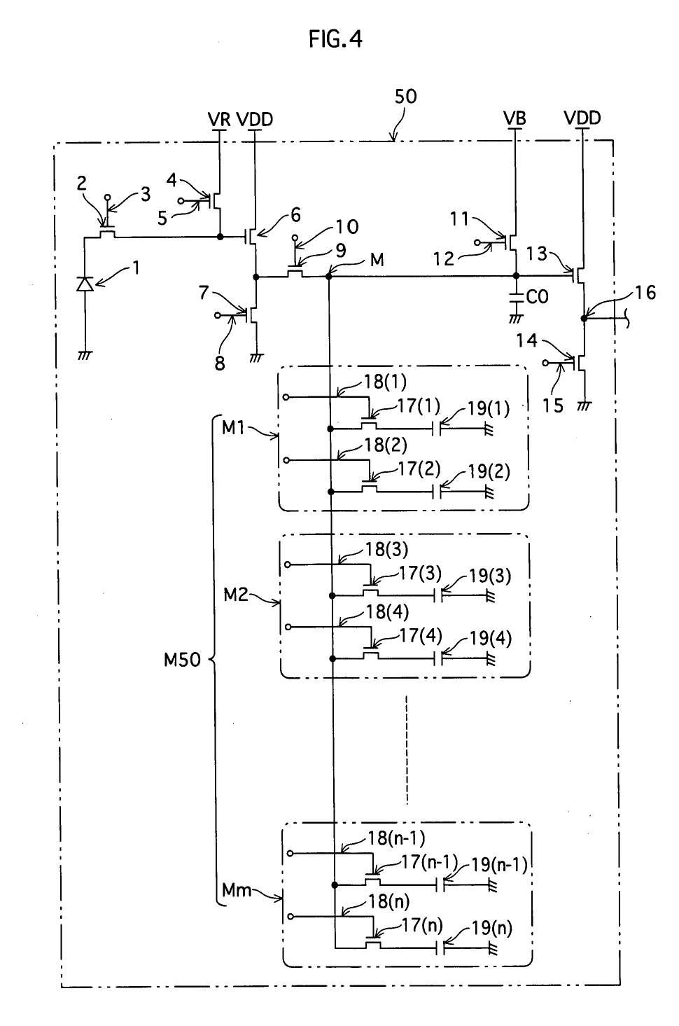

In the components of the MOS-type solid-state imaging device 100, structures of the image pixels 50 (11) to 50 (LM) will be described with reference to FIG. 4. Note that because all of the image pixels 50 (11) to 50 (LM) have the same structures on a circuit surface in the MOS-type solid-state imaging device 100, one image pixel is extracted and the extracted image pixel will be described as an image pixel 50 in what follow.

As shown in FIG. 4, the image pixel 50 in the MOS-type solid-state imaging device 100 is composed of a light receiving element 1, a plurality of MOS transistors 2, 4, 6, 7, 9, 11, 13, and 14, and a storage unit M50. The MOS transistor 2 is connected to the light receiving element 1, and is an element for performing switching of light receiving-signal transfer (hereinafter, referred also to as “transfer MOS transistor 2”) The MOS transistor 4 is a MOS transistor for reset (hereinafter, referred also to as “reset MOS transistor 4”), and a drain thereof is set at a desired electric potential VR.

The MOS transistors 6 and 7 form a source follower, a drain of the MOS transistor 6 is connected to electric power supply VDD, and a source of the MOS transistor 6 is connected to a drain of the MOS-transistor 7. A bias voltage is supplied to a gate 8 of the MOS transistor 7.

The MOS transistor 9 is inserted in a signal path between the light receiving element 1 and the storage unit M50, and switches between storing of a signal in the storage unit M50 and reading a signal from the storage unit M50 by an opening and closing operation. In the MOS transistor 11, a drain is set at a desired electric potential VB, and a source is connected to a source of the MOS transistor 9 and a gate of the MOS transistor 13. Note that the storage unit M50 is connected to a connection point M between the source of the MOS transistor 9 and the source of the MOS transistor 11. When the MOS transistor 11 is put into a conduction state, the connection point M is set at the electric potential VB.

The MOS transistors 13 and 14 form a source follower. A drain of the MOS transistor 13 is connected to electric power supply VDD, and a source of the MOS transistor 13 is connected to a drain of the MOS transistor 14. Also, a bias voltage is supplied to a gate 15 of the MOS transistor 14. A connection point 16 between the source of the MOS transistor 13 and the drain of the MOS transistor 14 is an output node (hereinafter, referred to as “output node 16”). Also, a floating capacitor C0 is formed in the connection point M and the source of the MOS transistor 11.

The storage unit M50 connected to the connection point M is composed of m storage pairs M1, M2, . . . , Mm. Each of the storage pairs M1, M2, . . . , Mm is composed of two MOS transistors and two capacitors. For example, the storage pair M1 is composed of MOS transistors 17 (1) and 17 (2), and capacitors 19 (1) and 19 (2). In the storage pair M1, drains of the MOS transistors 17 (1) and 17 (2) are connected to the source of the MOS transistor 9 and the source of the MOS transistor 11 via the connection point M, and sources of the MOS transistors 17 (1) and 17 (2) are connected to the capacitors 19 (1) and 19 (2) respectively. Other terminals of the capacitors 19 (1) and 19 (2) are connected to ground.

Also, in the storage pair M1, a storage element composed of the MOS transistor 17 (1) and the capacitor 19 (1), and a storage element composed of the MOS transistor 17 (2) and the capacitor 19 (2) are physically separated and these storage elements make a pair.

Other storage pairs M2, M3, . . . , Mm in the storage unit M50 have the same structure as the storage pair M1. Also, a signal for one frame is stored in each of the storage pairs M1, M2, . . . , Mm.

The MOS-type solid-state imaging device 100 of the first embodiment adopts the structure in which the storage unit M50 is composed of the m storage pairs M1, M2, . . . , Mm as an example, and the structure can realize high-speed photographing of (m) frames.

### 4. Drive in Image Pixel 50

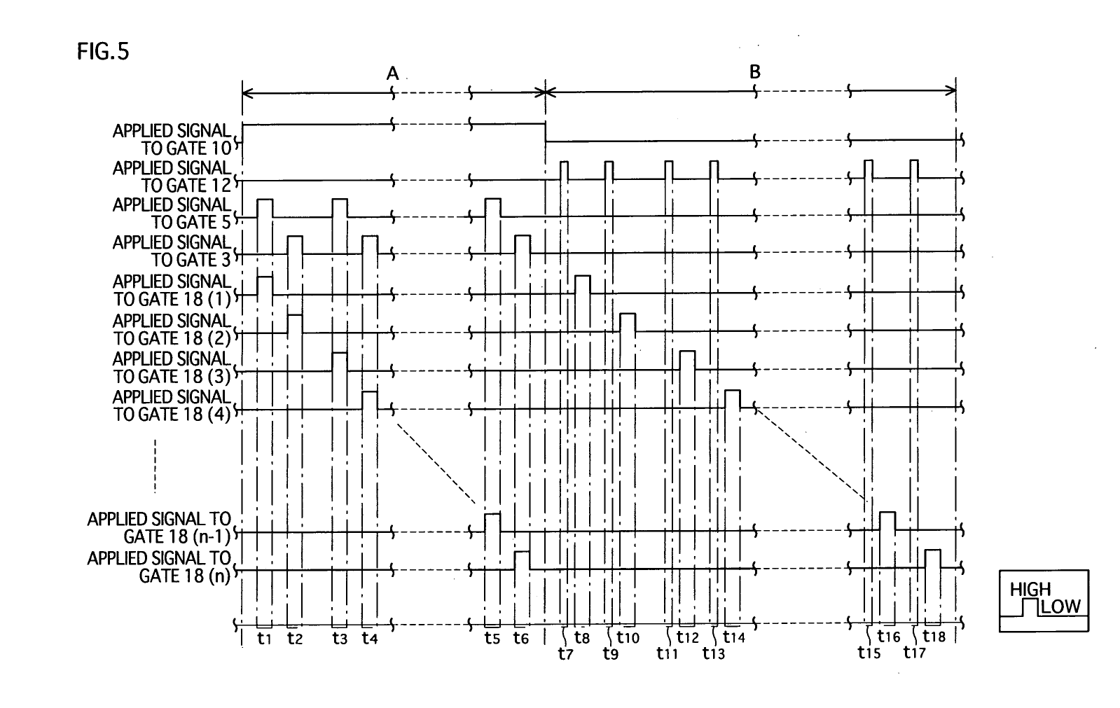

The following describes a drive in the image pixel 50 in the MOS-type solid-state imaging device 100 of the first embodiment, with reference to FIGS. 3 to 5. FIG. 5 is a timing chart showing an applied timing of a signal to each gate when driving the image pixel 50 in the MOS-type solid-state imaging device 100 of the first embodiment. In FIG. 5, a period for accumulating a signal (light receiving signal, noise) in the storage unit M50 is referred to as an accumulation period A, and a period for reading the signal accumulated in the storage unit M50 is referred to as a reading period B.

Also, in FIG. 5, when applying high level signals to gates 10, 12, 5, 3, and 18 (1) to 18 (n), the MOS transistors 9, 11, 4, 2, and 17 (1) to 17 (n) become a conduction state, and when applying low level signals to the gates 10, 12, 5, 3, and 18 (1) to 18 (n), the MOS transistors 9, 11, 4, 2, and 17 (1) to 17 (n) become a non-conduction state. Note that as shown in FIG. 5, in the accumulation period A, a high level signal is applied to the gate 10 of the MOS transistor 9, and the MOS transistor 9 is put into the conduction state. Also, in the reading period B, a low level signal is applied to the gate 10, and the MOS transistor 9 is put into the non-conduction state.

(1) Accumulation Period A

Firstly, for a period t1 for the accumulation period A, high level signals are applied to the gates 5 and 18 (1) of the MOS transistors 4 and 17 (1). Because of the signal application, the MOS transistors 4, 9, and 17 (1) are put into the conduction state, and a voltage signal having an initial level (VR) is accumulated in the capacitor 19 (1) in the storage pair M1 via the source follower for the period t1. This voltage signal, having the initial level (VR) corresponds to a base signal in a state in which the light receiving element 1 does not receive light.

Then, for a period t2, high level signals are applied to the gates 3 and 18 (2) of the MOS transistors 2 and 17 (2). Because of the signal application, the MOS transistors 2, 9, and 17 (2) are put into the conduction state, and a light receiving signal corresponding to a charge generated in the light receiving element 1 is accumulated in the capacitor 19 (2) in the storage pair M1 via the source follower for the period t2.

For a period t3, high level signals are applied to the gates 5 and 18 (3) of the MOS transistors 4 and 17 (3), and the MOS transistors 4 and 17 (3) are put into the conduction state in addition to the MOS transistor 9. Because of this, a voltage signal having the initial level (VR) is accumulated in the capacitor 19 (3) in the storage pair M2 via the source follower for the period t3.

For a period t4, high level signals are applied to the gates 3 and 18 (4) of the MOS transistors 2 and 17 (4), and the MOS transistors 2 and 17 (4) are put into the conduction state in addition to the MOS transistor 9. Because of this, a light receiving signal corresponding to a charge generated in the light receiving element 1 is accumulated in the capacitor 19 (4) in the storage pair M2 via the source follower for the period t4.

For a period t5, high level signals are applied to the gates 5 and 18 (n−1) of the MOS transistors 4 and 17 (n−1), and the MOS transistors 4 and 17 (n−1) are put into the conduction state in addition to the MOS transistor 9. Because of this, a voltage signal having the initial level (VR) is accumulated in the capacitor 19 (n−1) in the storage pair Mm via the source follower for the period t5.

For a period t6, high level signals are applied to the gates 3 and 18 (n) of the MOS transistors 2 and 17 (n), and the MOS transistors 2 and 17 (n) are put into the conduction state in addition to the MOS transistor 9. Because of this, a light receiving signal corresponding to a charge generated in the light receiving element 1 is accumulated in the capacitor 19 (n) in the storage pair Mm via the source follower for the period t6.

As mentioned above, for the accumulation period A, the voltage signal having the initial level (VR) corresponding to the signal in a case in which the light receiving element 1 does not receive light is accumulated in each of the capacitors 19 (1), 19 (3), . . . , 19 (n−1) in the storage pairs M1, M2, Mm in the storage unit M50. Also, the light receiving signal corresponding to the charge generated in the light receiving element 1 is accumulated, in order of time, in each of the capacitors 19 (2), 19 (4), . . . , 19 (n) which are pairs of the capacitors 19 (1), 19 (3), . . . , 19 (n−1) in the storage pairs M1, M2, . . . , Mm.

Note that when the capacitors 19 (1) to 19 (n) in the storage unit M50 are divided into groups, a first group includes the capacitors 19 (1), 19 (3), . . . , 19 (n−1), and a second group includes the capacitors 19 (2), 19 (4), . . . , 19 (n).

(2) Reading Period B

Next, for a period t7 for the reading period B, because a high level signal is applied to the gate 12, the MOS transistor 11 is put into the conduction state, and an electric potential level of the connection point M is set at an electric potential VB.

For a period t8, because a high level signal is applied to the gate 18 (1), the MOS transistor 17 (1) in the storage pair M1 is put into the conduction state. Because of this, a divided voltage of the voltage signal having the initial level (VR) accumulated in the capacitor 19 (1) in the storage pair M1 and the floating capacitor C0 is generated in the connection point M, and the generated divided voltage is outputted to the output node 16 via the source follower composed of the MOS transistors 13 and 14.

For a period t9, because a high level signal is applied to the gate 12 again, the MOS transistor 11 is put into the conduction state, and the electric potential level of the connection point M is set at the electric potential VB. For a period t10, because a high-level signal is applied to the gate 18 (2) in the storage pair M1, the MOS transistor 17 (2) is put into t10, conduction state. Because of this, a divided voltage of the light receiving signal accumulated in the capacitor 19 (2) in the storage pair M1 and the floating capacitor C0 is generated in the connection point M, and the generated divided voltage is outputted to the output node 16 via the source follower composed of the MOS transistors 13 and 14.

As mentioned above, the divided voltage corresponding to the voltage signal having the initial level (VR) for the period t8 and the divided voltage corresponding to the light receiving signal for the period t10 are outputted to the output node 16 in time series.

For periods t11 to t14, the same operations as in the periods t7 to t10 are performed on the storage pair M2. Also, the divided voltage corresponding to a voltage signal having the initial level (VR) for the period t12 and the divided voltage corresponding to a light receiving signal for the period t14 are outputted to the output node 16 in time series.

For periods t15 to t18, the same operations as in the periods t7 to t10, and the periods t11 to t14 are performed on the storage pair Mm. Also, the divided voltage corresponding to a voltage signal having the initial level (VR) for the period t16 and the divided voltage corresponding to a light receiving signal for the period t18 are outputted to the output node 16 in time series. Note that the same reading operations are performed on the storage pairs M3 to M (m−1) in the image pixel 50.

### 5. Drive of MOS-Type Solid-State Imaging Device 100

The following describes a drive of the MOS-type solid-state imaging device 100 along with the execution of the above-mentioned drive in the image pixels 50 (11) to 50 (LM), with reference to FIGS. 5 and 3 based on the drive of the image pixel 50.

As shown in FIG. 3, when a signal is outputted to the signal output line 57 (1) from the vertical scanning circuit 56, the MOS transistors 51 (11) to 51 (L1) are put into the conduction state, leading to a state in which signals of the output nodes 16 of the image pixels 50 (11) to 50 (L1) are transmitted to the common vertical signal lines 52 (1) to 52 (L) respectively. In this state, noise and a light receiving signal are inputted to the noise-canceling circuits 53 (1) to 53 (L) for each column for the periods t8 and t10 shown in FIG. 5. In the noise-canceling circuits 53 (1) to 53 (L) for each column, a differential signal between the divided voltage corresponding to the noise and the divided voltage corresponding to the light receiving signal is outputted.

Note that a CDS (Correlated Double Sampling) circuit for removing noise can be conventionally used for the noise-canceling circuits 53 (1) to 53 (L), and an explanation of the operation is omitted.

Next, when signal are outputted to the signal output lines 59 (1) to 59 (L) which are extended from the horizontal scanning circuit 58 shown in FIG. 3 in time series, the MOS transistors 54 (1) to 54 (L) are sequentially put into the conduction state in response to the output, and the differential signals are outputted from the noise-canceling circuits 53 (1) to 53 (L) to the common signal line 55 in time series. The above-mentioned operation is repeated until the periods t16 and t18 shown in FIG. 3, and (n/2) differential signals can be obtained.

In the MOS-type solid-state imaging device 100 of the first embodiment, the same operation is repeated until the image pixels 50 (1M) to 50 (LM). As a result, in the MOS-type solid-state imaging device 100 of the first embodiment, image signals of (n/2) frames can be obtained by (L×M) pixels at high speed.

### 6. Advantage

As mentioned above, in the MOS-type solid-state imaging device 100 of the first embodiment, the n capacitors 19 (1) to 19 (n) are provided in the storage units M50 of the image pixels 50 (11) to 50 (LM). Also, the light receiving signals corresponding to the charges generated in the light receiving element 1 are accumulated in the capacitors 19 (2), 19 (4), . . . , 19 (n) in time series. Therefore, an image drive at a high speed of equal to or larger than 10000 frame rates can be realized.

Moreover, noise (reset signal) can be accumulated in the capacitors 19 (1), 19 (3), . . . , 19 (n−1) which are pairs of the capacitors 19 (2), 19 (4), . . . , 19 (n), and a difference between a signal corresponding to a light receiving signal and noise can be outputted in the noise-canceling circuits 53 (1) to 53 (L) in a latter part. As a result, high-speed photographing of (2/n) frames with high quality and less noise can be realized.

Also, since the MOS-type solid-state imaging device 100 is adopted as an image device in the first embodiment, high-speed photographing with high quality can be achieved as mentioned above, and an increase of electric power consumption can be suppressed. In other words, in the conventional CCD-type solid-state imaging device of the patent document, a high voltage pulse in a range of 9 [V] to 12 [v] inclusive is required to be applied in order to transfer charges to a plurality of formed CCDs. As a result, a large amount of electric power is consumed to accumulate a plurality of signals. On the other hand, in the MOS-type solid-state imaging device 100 of the first embodiment, the light receiving-signal and the noise can be accumulated in the capacitors 19 (1) to 19 (n) in a state of being physically separated from each other, by the opening and closing operation by the MOS transistors 2, 9, and 17 (1) to 17 (n). Therefore, in the MOS-type solid-state imaging device 100 of the first embodiment, high-speed photographing can be realized without executing the charge transfer operation as in the CCD-type solid-state imaging device of the patent document, and an increase of electric power consumption can be suppressed.

Note that although an amplifier composed of the MOS transistors 6 and 7 is used in the MOS-type solid-state imaging device 100 of the first embodiment as shown in FIG. 4, the same effect can be obtained if a structure without the amplifier is adopted.

### Second Embodiment

### 1. Structure of Image Pixel 150

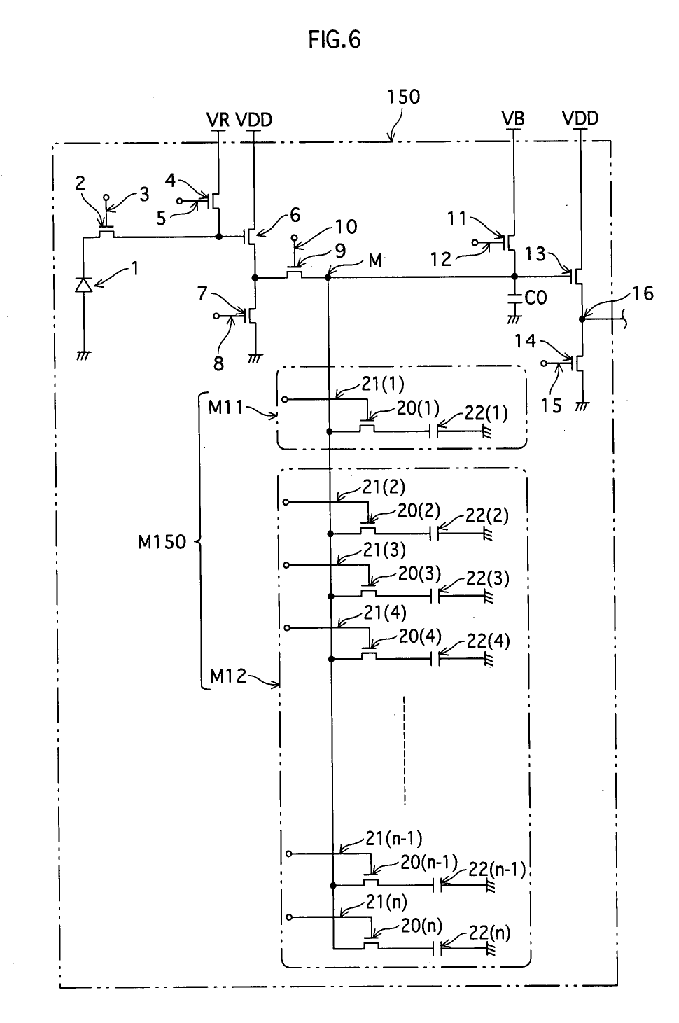

The following describes a structure of a MOS-type solid-state imaging device of a second embodiment with reference to FIG. 6. Note that in the MOS-type solid-state imaging device of the second embodiment, a structure of a storage unit M150 in an image pixel 150 is different from the MOS-type solid-state imaging device 100 of the first embodiment, and other components are same as the first embodiment. Therefore, the explanations of other components are omitted. Also, in FIG. 6, the same symbols as in the image pixel 50 are assigned to the component parts having the same structures in the image pixel 150.

As shown in FIG. 6, in the MOS-type solid-state imaging device of the second embodiment, the storage unit M150 in the image pixel 150 is composed of storage groups M11 and M12. The storage group M11 is composed of a MOS transistor 20 (1) and a capacitor 22 (1). On the other hand, the storage group M12 is composed of (n−1) MOS transistors 20 (2) to 20 (n) and (n−1) capacitors 22 (2) to 22 (n).

### 2. Drive

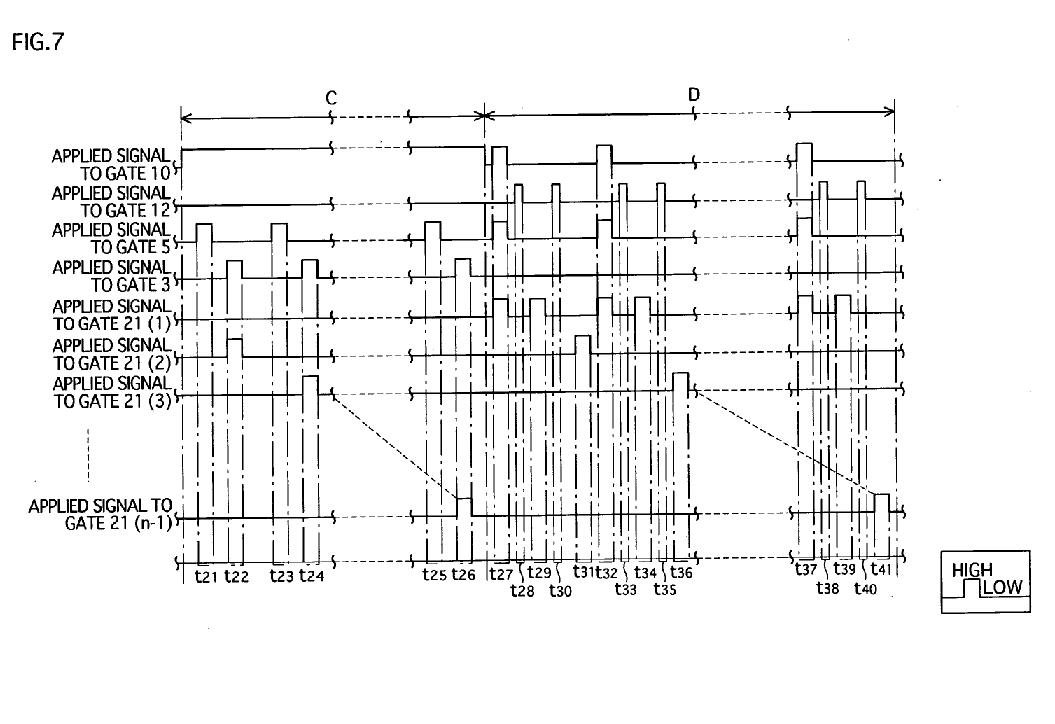

The following describes an operation of the MOS-type solid-state imaging device of the second embodiment with reference to FIG. 7. In a timing chart shown in FIG. 7, a period for accumulating a signal (light receiving signal, noise) in the storage unit M150 is referred to as an accumulation period C, and a period for reading the signal accumulated in the storage unit M150 is referred to as a reading period D.

As shown in FIG. 7, for the accumulation period C, a high level signal is applied to the gate 10, and the MOS transistor 9 is put into the conduction state. For the reading period D, an applied signal to the gate 10 is set at a low level except for periods t27, t32, and t37, and the MOS transistor 9 is put into the non-conduction state.

For a period t21, a high level signal is applied to the gate 5, the MOS transistor 4 is put into the conduction state, and the gate of the MOS transistor 6 is set at an electric potential of an initial level (VR).

After that, for a period t22, high level signals are applied to the gates 3 and 21 (2), and the MOS transistors 2 and 20 (2) are put into the conduction state in addition to the MOS transistor 9. Because of this, a light receiving signal corresponding to a charge generated in the light receiving element 1 is accumulated in the capacitor 22 (2) in the storage group M12 via the source follower for the period t22.

In the same manner as this, light receiving signals are accumulated in capacitors 22 (3) to 22 (n) in the storage group M12 for periods t24 to t26.

Note that when driving the MOS-type solid-state imaging device of the second embodiment, a high level signal is applied to the gate 5 before executing the operations of accumulating the light receiving signals in the capacitors 22 (2) to 22 (n) in the storage group M12 (the periods t23 to t25), and the gate of the MOS transistor 6 is set at the electric potential of the initial level (VR).

Next, for a period t27, high level signals are applied to the gates 10, 5, and 21 (1), and the MOS transistors 4, 9, and 20 (1) are put into the conduction state. Note that the MOS transistor 2 is in a closed state for the period t27. For the period t27, noise is accumulated in the capacitor 22 (1) in the storage group M11 via the source follower by executing the operation.

For a period t28 for the reading period D, because a high level signal is applied to the gate 12, the MOS transistor 11 is put into the conduction state, and an electric potential level of the connection point M is set at an electric potential VB. For a period t29, because a high level signal is applied to the gate 21 (1), the MOS transistor 20 (1) in the storage group M11 is put into the conduction state. Because of this, a divided voltage of the voltage signal (noise) having the initial level (VR) accumulated in the capacitor 22 (1) and the floating capacitor C0 is generated in the connection point M, and the generated divided voltage is outputted to the output node 16 via the source follower composed of the MOS transistors 13 and 14 for the period t29. For a period t30, because a high level signal is applied to the gate 12 again, the MOS transistor 11 is put into the conduction state, and the electric potential level of the connection point M is reset at the electric potential VB.

For a period t31, because a high level signal is applied to the gate 21 (2), the MOS transistor 20 (2) in the storage group N12 is put into the conduction state. Because of this, a divided voltage of the light receiving signal accumulated in the capacitor 22 (2) and the floating capacitor C0 is generated in the connection point M, and the generated divided voltage is out putted to the output node 16 via the source follower composed of the MOS transistors 13 and 14 for the period t31.

For periods t32 to t41, the same operations as in the periods t27 to t31 are performed. Also, the divided voltages corresponding to the light receiving signals accumulated in the capacitors 22 (3) to 22 (n) in the storage group M12 and the divided voltage corresponding to the voltage signal (noise) having the initial level (VR) which is temporarily accumulated in the capacitor 22 (1) in the storage group M11 are alternately outputted to the output node 16.

As mentioned above, the MOS-type solid-state imaging device of the second embodiment adopts the same structure as the MOS-type solid-state imaging device 100 except for the structure of the storage unit M150 of the image pixel 150. Therefore, in the MOS-type solid-state imaging device of the second embodiment, a signal output can be obtained by performing the differential process on the light receiving signal and the noise (electric potential signal having an initial level VR) which are outputted from the image pixel 150 in time series in the noise-canceling circuit (refer to FIG. 3) provided in a latter part of the output node 16.

### 3. Advantage

As mentioned above, in the MOS-type solid-state imaging device of the second embodiment, the n capacitors 22 (1) to 22 (n) are provided in the storage unit M150 of the image pixel 150, and the light receiving signals are accumulated in the (n−1) capacitors 22 (2) to 22 (n) out of the n capacitors. Also, (n−1) noises can be accumulated in and read from the capacitor 22 (1) which is provided in the storage group M11 in the storage unit M150 in the image pixel 150, in a state of being temporally separated.

In the MOS-type solid-state-imaging device of the second embodiment characterized by the above-mentioned structure, a process of obtaining a difference between both output signals can be performed at a high speed of equal to or larger than 10000 frame rates in the noise-canceling circuits 53 (1) to 53 (L), and a high quality image signal whose noise is canceled can be outputted. Therefore, in the MOS-type solid-state imaging device of the second embodiment, even when the number of capacitors for each image pixel 150 is same as in the image pixel 50 of the first embodiment, high-speed photographing of an image with high quality and less noise can be realized by (n−1) frames which is more than the MOS-type solid-state imaging device 50 of the first embodiment.

Also, if the MOS-type solid-state imaging device of the second embodiment is applied as an image device of a camera, the MOS-type solid-state imaging device has an advantage that high-speed photographing of an image with high quality can be realized while suppressing an increase, of electric power consumption.

Note that although the structure in which the image pixel 150 includes an amplifier composed of the MOS transistors 6 and 7 is applied in the second embodiment as an example, the same effect can be obtained if a structure without an amplifier is applied. Also, in the MOS-type solid-state imaging device of the second embodiment, the storage unit M150 in the image pixel 150 is composed of the storage group M11 including the capacitor 22 (1) and the storage group M12 including (n−1) capacitors 22 (2) to 22 (n). However, the number of the storage groups in the storage unit M150, the number of the capacitors 22 (1), and 22 (2) to 22 (n) in the storage groups M11 and M12, and the arrangement are not limited to these.

### Third Embodiment

### 1. Structure of MOS-Type Solid-State Imaging Device

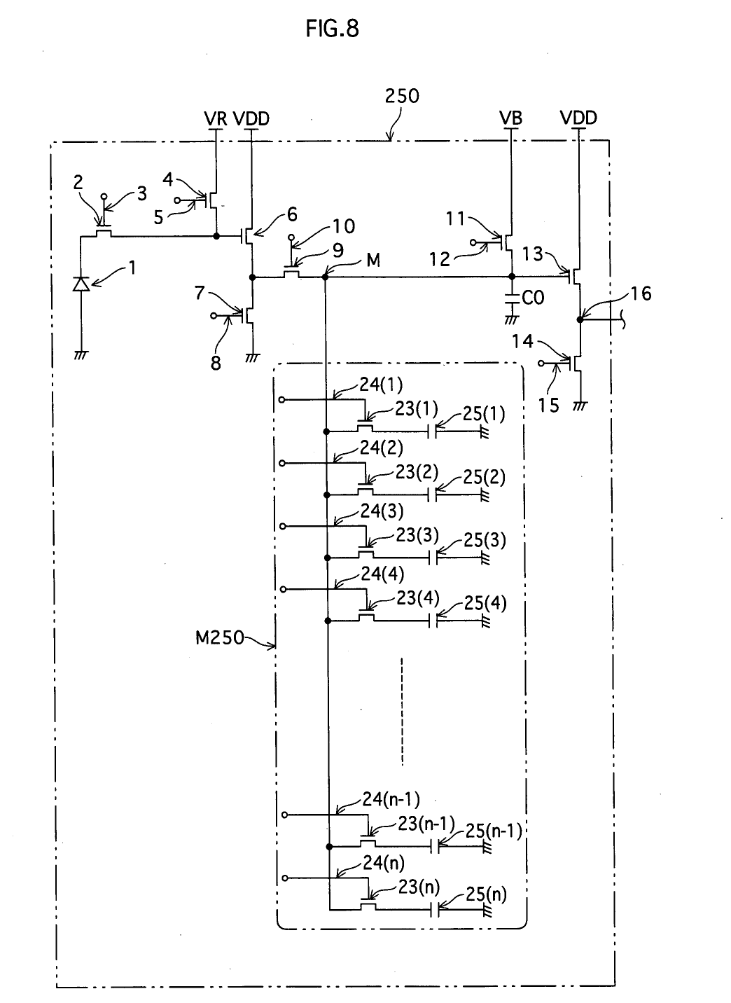

The following describes a structure of a MOS-type solid-state imaging device of a third embodiment with reference to FIG. 8. Note that in the MOS-type solid-state imaging device of the third embodiment, a structure of a storage unit M250 in an image pixel 250 is different from the MOS-type solid-state imaging device 100 and the like of the first and the second embodiments, and other components are same as the first and second embodiments. Therefore, the explanations of other components are omitted. Also, in FIG. 8, the same symbols as in the image pixels 50 and 150 are assigned to the component parts having the same structures in the image pixel 250.

As shown in FIG. 8, in the MOS-type solid-state imaging device of the third embodiment, the storage unit M250 in the image pixel 250 is composed of n MOS transistors 23 (1) to 23 (n) and n capacitors 25 (1) to 25 (n), and the storage group is not divided unlike the first and second embodiments. In other words, in the MOS-type solid-state imaging device of the third embodiment, the n capacitors 25 (1) to 25 (n) in the storage unit M250 are shared as a noise accumulating capacitor and a light receiving signal accumulating capacitor in the image pixel 250.

### 2. Drive

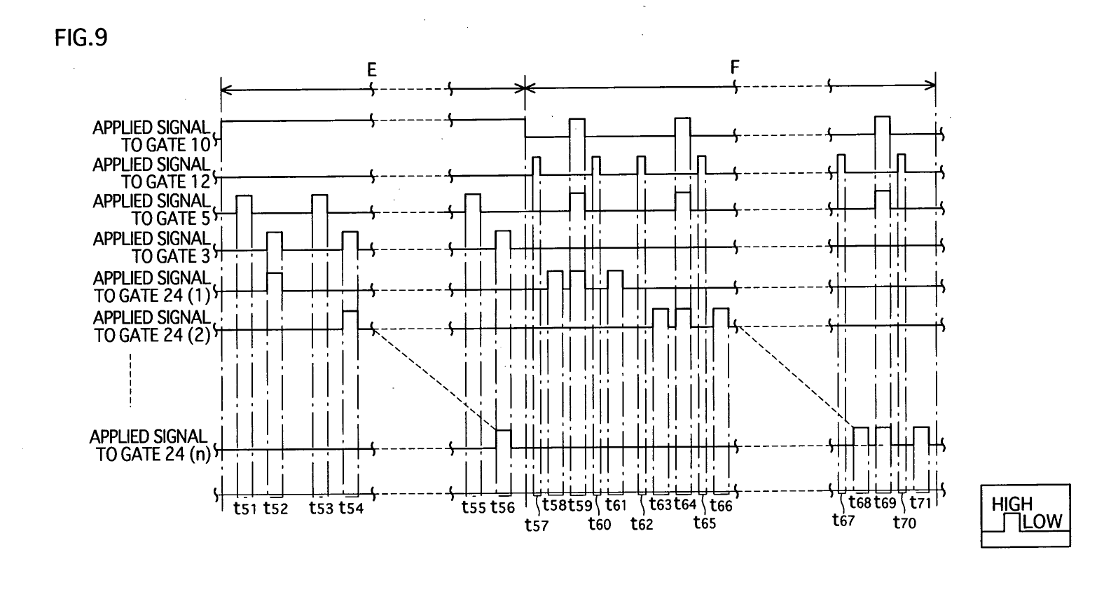

The following describes an operation of the MOS-type solid-state imaging device of the third embodiment with reference to FIG. 9. Note that in a timing chart shown in FIG. 9, a period for accumulating a signal (light receiving signal, noise) in the storage unit M250 is referred to as an accumulation period E, and a period for reading the signal accumulated in the storage unit M250 is referred to as a reading period F.

As shown in FIG. 9, for the accumulation period E, a high level signal is applied to the gate 10, and the MOS transistor 9 is put into the conduction state. For the reading period F, an applied signal to the gate 10 is set at a low level except for periods t59, t64, and t69, and the MOS transistor 9 is put into the non-conduction state.

For a period t51, a high level signal is applied to the gate 5, the MOS transistor 4 is put into the conduction state, and the gate of the MOS transistor 6 is set at an electric potential of an initial level (VR). After that, for a period t52, high level signals are applied to the gates 3 and 24 (1), and the MOS transistors 2 and 23 (1) are put into the conduction state in addition to the MOS transistor 9. Because of this, a light receiving signal corresponding to a charge generated in the light receiving element 1 is accumulated in the capacitor 25 (1) in the storage unit M250 via the source follower for the period t52.

In the same manner as this, light receiving signals are accumulated in the capacitors 25 (2) to 25 (n) in the storage unit M250 for periods t54 to t56.

Note that as in the case of the MOS-type solid-state imaging device of the second embodiment, when driving the MOS-type solid-state imaging device of the third embodiment, a high level signal is applied to the gate 5 before executing the operations of accumulating the light receiving signals in the capacitors 25 (2) to 25 (n) in the storage unit M250 (the periods t53 to t55), and the gate of the MOS transistor 6 is set at the electric potential of the initial level (VR).

As mentioned above, the light receiving signals are accumulated in all of the capacitors 25 (1) to 25 (n) in the storage unit M250 for the accumulation period E.

For a period t57 for the reading period F, because a high level signal is applied to the gate 12, the MOS transistor 11 is put into the conduction state. Because of this, an electric potential level of the connection point M is set at an electric potential VB. For a period t58, because a high level signal is applied to the gate 24 (1), the MOS transistor 23 (1) is put into the conduction state. Because of this, for the period t57, a divided voltage of the voltage signal having the initial level (VR) accumulated in the capacitor 25 (1) in the storage unit M250 and the floating capacitor C0 is generated in the connection point M, and the generated divided voltage is outputted to the output node 16 via the source follower composed of the MOS transistors 13 and 14.

For a period t59, because high level signals are applied to the gates 10, 5, and 24 (1), the MOS transistors 4, 9, and 23 (1) are put into the conduction state. Because of this, noise is accumulated in the capacitor 25 (1) in the storage unit M250 via the source follower for the period t59. For a period t60, because a high level signal is applied to the gate 12, the MOS transistor 11 is put into the conduction state. Because of this, the electric potential level of the connection point M is set at the electric potential VB.

For a period t61, because a high level signal is applied to the gate 24 (1) again, the MOS transistor 23 (1) is put into the conduction state. Because of this, for the period t61, a divided voltage of the voltage signal having the initial level (VR) accumulated in the capacitor 25 (1) in the storage unit M250 and the floating capacitor C0 is generated in the connection point M, and the generated divided voltage is outputted to the output node 16 via the source follower composed of the MOS transistors 13 and 14. In other words, for the period t58, the divided voltage corresponding to the light receiving signal is outputted to the output node 16, and for the period t61, the divided voltage corresponding to the noise is outputted to the output node 16. This structure is different from the structures of the first and second embodiments in which the noise is outputted first, then the light receiving signal is outputted, and an order of outputting a signal is different from the first and second embodiments.

For periods t62 to t71, the same operations as in the periods t57 to t61 are performed. Also, the divided voltages corresponding to the light receiving signals and the divided voltage corresponding to the voltage signal (noise) having the initial level (VR) are alternately outputted to the output node 16 from the capacitors 25 (2) to 25 (n) in the storage unit M250 in time series.

As mentioned above, the MOS-type solid-state imaging device of the third embodiment adopts the same structure as the MOS-type solid-state imaging device 100 and the like, except for the structure of the storage unit M250 of the image pixel 250. Therefore, in the MOS-type solid-state imaging device of the third embodiment, a signal output with high image quality can be obtained at high speed by performing the differential process on the light receiving signal and the noise (electric potential signal having the initial level of VR) which are outputted from the image pixel 250 in time series, in the noise-canceling circuit (refer to FIG. 3) provided in a latter part of the output node 16.

### 3. Advantage

As mentioned above, in the MOS-type solid-state imaging device of the third embodiment, the n capacitors 25 (1) to 25 (n) are provided in the storage unit M250 of the image pixels 250, and the light receiving signal and the noise can be accumulated and read in a state of being temporally separated. Therefore, in the MOS-type solid-state imaging device of the third embodiment, the same number of light receiving signals and noises as the capacitors 25 (1) to 25 (n) provided in the storage unit M250 of the image pixels 250 can be accumulated, and a high quality output signal with less noise can be obtained at high speed using a compact structure.

In the MOS-type solid-state imaging device of the third embodiment characterized by the above-mentioned structure, a process of obtaining a difference between both output signals can be performed at a high speed of equal to or larger than 10000 frame rates in the noise-canceling circuits 53 (1) to 53 (L), and a high quality image signal whose noise is canceled can be outputted. Therefore, in the MOS-type solid-state imaging device of the third embodiment, even when the number of capacitors for each image pixel 250 is same as in the image pixels 50 and 150 of the first and second embodiments, high-speed photographing of an image with high quality and less noise can be realized by n frames which is more than the MOS-type solid-state imaging devices of the first and second embodiments.

Also, if the MOS-type solid-state imaging device of the third embodiment is applied as an image device of a camera, the MOS-type solid-state imaging device has an advantage that high-speed photographing of an image with high quality can be realized while suppressing an increase of electric power consumption.

Note that although the structure in which the image pixel 250 includes an amplifier composed of the MOS transistors 6 and 7 is applied in the third embodiment as an example, the same effect can be obtained if a structure without the amplifier is applied. Also, in the MOS-type solid-state imaging device of the third embodiment, the storage unit M250 in the image pixel 250 is composed of the n capacitors 25 (1) to 25 (n). However, the number of the capacitors in the storage unit M250 and the arrangement are not limited to these.

### Fourth Embodiment

### 1. Structure of MOS-Type Solid-State Imaging Device

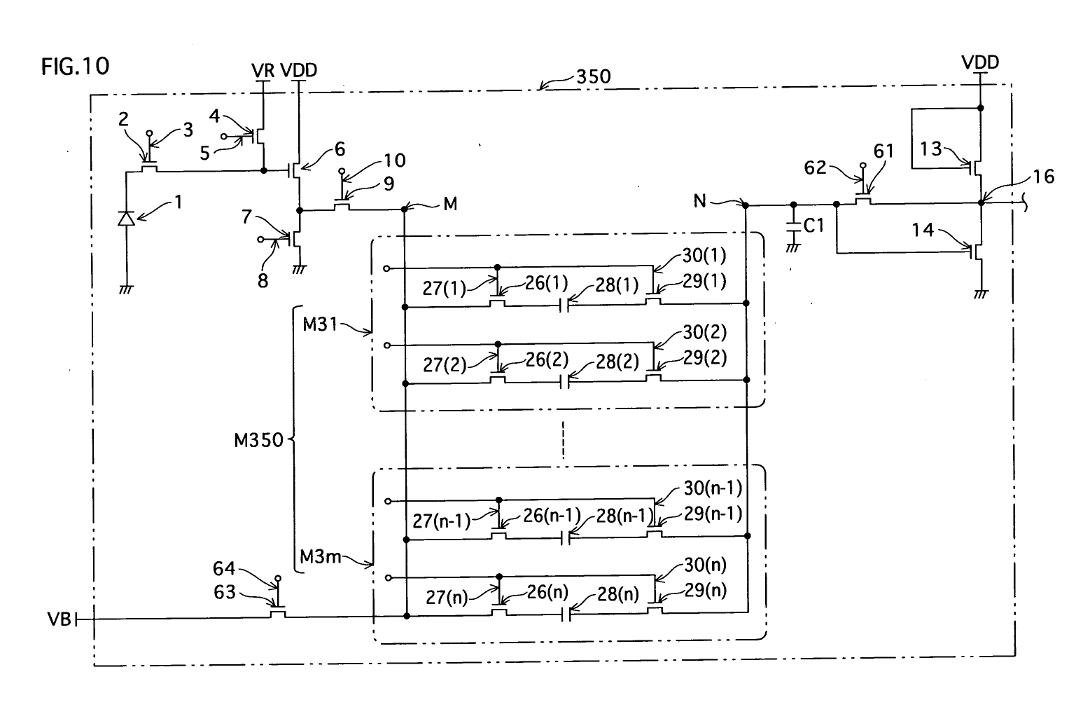

The following describes a structure of a MOS-type solid-state imaging device of a fourth embodiment with reference to FIG. 10. Note that in the MOS-type solid-state imaging device of the fourth embodiment, a structure of a storage unit M350 in an image pixel 350 and a circuit structure from the storage unit M350 to the output node 16 are different from the MOS-type solid-state imaging device 100 and the like of the first to third embodiments. Also, other components are same as the first to third embodiments. Therefore, the explanations of other components are omitted. Moreover, in FIG. 10, the same symbols as in the image pixels 50 to 250 are assigned to the component parts having the same structures in the image pixel 350.

As shown in FIG. 10, in the MOS-type solid-state imaging device of the fourth embodiment, the storage unit M350 in the image pixel 350 is composed of m storage pairs M31 to M3m. Each of the m storage pairs M31 to M3m is composed of four MOS transistors and two capacitors. For example, the storage pair M31 is composed of four MOS transistors 26 (1), 26 (2), 29 (1), and 29 (2), and two capacitors 28 (1) and 28 (2).

Drains of the MOS transistors 29 (1) to 29 (n) of the storage pairs M31 to M3m in the storage unit M350 are connected to capacitors 28 (1) to 28 (n) respectively, and sources of the MOS transistors 29 (1) to 29 (n) is connected to a connection point N. In the storage pairs M31 to M3m, gates 27 (1) to 27 (n) of MOS transistor 26 (1) to 26 (n), which are connected to capacitors 28 (1) to 28 (n) respectively, are connected to gates 30 (1) to 30 (n) of MOS transistor 29 (1) to 29 (n), which are connected to capacitors 28 (1) to 28 (n) respectively.

In the image pixel 350 of the fourth embodiment, the storage unit M350 is inserted in a signal path between the light receiving element 1 and the output node 16 in series. More specifically, one end of the storage unit M350 is connected to the connection point M on the light receiving element 1 side, and the other end of the storage unit M350 is connected to the connection point N on the output node 16 side.

Also, the one end of the storage unit M350 which is connected to the connection point M is connected to a source of a MOS transistor 63. A drain of the MOS transistor 63 is set at a desired electric potential VB.

The connection point N is connected to a drain of a MOS transistor 61, and a floating capacitor C1 is formed in the connection point N. MOS transistors 13 and 14 which are connected to a source of the MOS transistor 61 compose an inverter circuit, a gate of the MOS transistor 13 is connected to a drain thereof, and a source of the MOS transistor 13 is connected to a drain of the MOS transistor 14. A connection point between the source of the MOS transistor 13 and the drain of the MOS transistor 14 is the output node 16. Also, a gate of the MOS transistor 14 is connected to one end of the floating capacitor C1 and the drain of the MOS transistor 61.

### 2. Drive

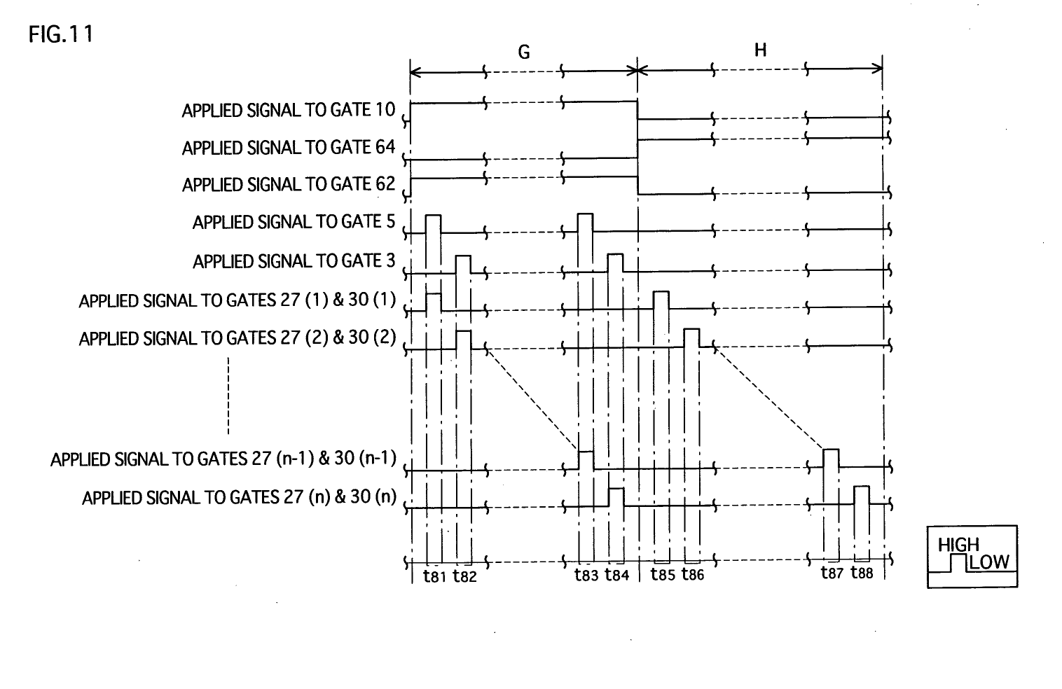

The following describes an operation of the MOS-type solid-state imaging device of the fourth embodiment with reference to FIG. 11. Note that in a timing chart shown in FIG. 11, a period for accumulating a signal (light receiving signal, noise) in the storage unit M350 is referred to as an accumulation period G, and a period for reading the signal accumulated in the storage unit M350 is referred to as a reading period H.

As shown in FIG. 11, for the accumulation period G, high level signals are applied to the gates 10 and 62, and the MOS transistors 9 and 61 are put into the conduction state. For the reading period H, applied signals to the gates 10 and 62 are set at low levels, and the MOS transistors 9 and 61 are put into the non-conduction state. Also, for the accumulation period G, a low level signal is applied to the gate 64, and the MOS transistor 63 is put into the non-conduction state. For the reading period H, an applied signal to the gate 64 is set at a high level, and the MOS transistor 63 is put into the conduction state.

As shown in FIG. 11, for a period t81, because high level signals are applied to the gates 5, 27 (1), and 30 (1), the MOS transistors 4, 26 (1), and 29 (1) are put into the conduction state in addition to the MOS transistors 9 and 61. Because of this, for the period t81, an electric potential signal having an initial level (VR) is accumulated in a terminal of the capacitor 28 (1) on the MOS transistor 26 (1) side in the storage pair M31 via the source follower. For the period t81, a voltage signal having a level of the output node 16 is accumulated in a terminal of the capacitor 28 (1) on the MOS transistor 29 (1) side.

Here, if a value of an electric potential level of the output node 16 for the period t81 is an electric potential V16, a signal having a level (VR-V16) is accumulated in the capacitor 28 (1). This electric potential having the initial level (VR) corresponds to a signal in a case in which the light receiving element 1 does not receive light.

For a period t82, because high level signals are applied to the gates 3, 27 (2), and 30 (2), the MOS transistors 2, 26 (2), and 29 (2) are put into the conduction state in addition to the MOS transistors 9 and 61. Because of this, for the period t82, a light receiving signal (VP) corresponding to a charge generated in the light receiving element 1 is accumulated in a terminal of the capacitor 28 (2) on the MOS transistor 26 (2) side in the storage pair M31 via the source follower. For the period t82, a voltage signal having a level of the output node 16 is accumulated in a terminal of the capacitor 28 (2) on the MOS transistor 29 (2) side. Therefore, a signal having a level (VP-V16) is accumulated in the capacitor 28 (2) for the period t82.

In the same manner as this, the signals having the level (VP-V16) are accumulated in the capacitors 28 (3) to 28 (n) in the storage unit M350 until a period t84.

Next, for a period t85 for the reading period H, because high level signals are applied to the gates 27 (1) and 30 (1), the MOS transistors 26 (1) and 29 (1) are put into the conduction state in addition to the MOS transistor 63. Because of this, for the period t85, an electric potential level of the connection point M is set at the electric potential VB, and the voltage held in the capacitor 28 (1) is outputted from the terminal on the MOS transistor 29 (1) side to the connection point N. In other words, for the period t85, a signal having a level (VR-V16-VB) is outputted to the connection point N, and a signal having a value corresponding to the voltage signal accumulated for the period t81 is outputted to the output node 16 of the inverter circuit composed of the MOS transistors 13 and 14.

For a period t86, because high level signals are applied to the gates 27 (2) and 30 (2), the MOS transistors 26 (2) and 29 (2) are put into the conduction state in addition to the MOS transistor 63. Because of this, for the period t86, the electric potential level of the connection point M is set at the electric potential VB, and the voltage held in the capacitor 28 (2) is outputted from the terminal on the MOS transistor 29 (2) side to the connection point N. In other words, for the period t86, a signal having a level (VR-V16-VB) is outputted to the connection point N, and a signal having a value-corresponding to the voltage signal accumulated for the period t82 is outputted to the output node 16 of the inverter circuit composed of the MOS transistors 13 and 14.

In the same manner as this, signals having values corresponding to the voltage signals accumulated in the capacitors 28 (3) to 28 (n) are outputted to the output node 16 until a period t88.

As mentioned above, in the MOS-type solid-state imaging device of the fourth embodiment, a signal corresponding to the noise is outputted to the output node 16 for the period t85, and a signal corresponding to the light receiving signal is outputted to the output node 16 for the period t86, for example.

As mentioned above, the MOS-type solid-state imaging device of the fourth embodiment adopts the same structure as the MOS-type solid-state imaging device 100 and the like except for the structure of the image pixel 350. Therefore, in the MOS-type solid-state imaging device of the fourth embodiment, a signal output with high image quality can be obtained at high speed by performing the differential process on the light receiving signal and the noise (electric potential signal having the initial level VR) which are outputted from the image pixel 350 in time series, in the noise-canceling circuit (refer to FIG. 3) provided in a latter part of the output node 16.

### 3. Advantage

As mentioned above, in the MOS-type solid-state imaging device of the fourth embodiment, the n capacitors 28 (1) to 28 (n) are provided in the storage unit M350 of the image pixels 350, and m (=n/2) pairs of noise and light receiving signal can be accumulated. Therefore, in the MOS-type solid-state imaging device of the fourth embodiment, a process of obtaining a difference between both output signals can be performed at a high speed of equal to or larger than 10000 frame rates in the noise-canceling circuits 53 (1) to 53 (L), and a high quality image signal whose noise is canceled can be outputted. Therefore, in the MOS-type solid-state imaging device of the fourth embodiment, high-speed photographing of an image with high quality and less noise can be realized while suppressing an increase of electric power consumption.

Also, if the MOS-type solid-state imaging device of the fourth embodiment is applied as an image-device of a camera, the MOS-type solid-state imaging device has an advantage that high-speed photographing of an image with high-quality can be realized while suppressing an increase of electric power consumption.

Note that although the structure in which the image pixel 350 includes an amplifier composed of the MOS transistors 6 and 7 is applied in the fourth embodiment as an example, the same effect can be obtained if a structure without the amplifier is applied. Also, in the MOS-type solid-state imaging device of the fourth embodiment, the storage unit M350 in the image pixel 350 is divided into the m storage pairs M31 to M3m, and a pair of capacitors is provided for each storage pair. However, the number of the storage pairs in the storage unit M350, the number of the capacitors in each of the storage pairs, and the arrangement are not limited to these.

### Fifth Embodiment

### 1. Structure of Image Pixel 450

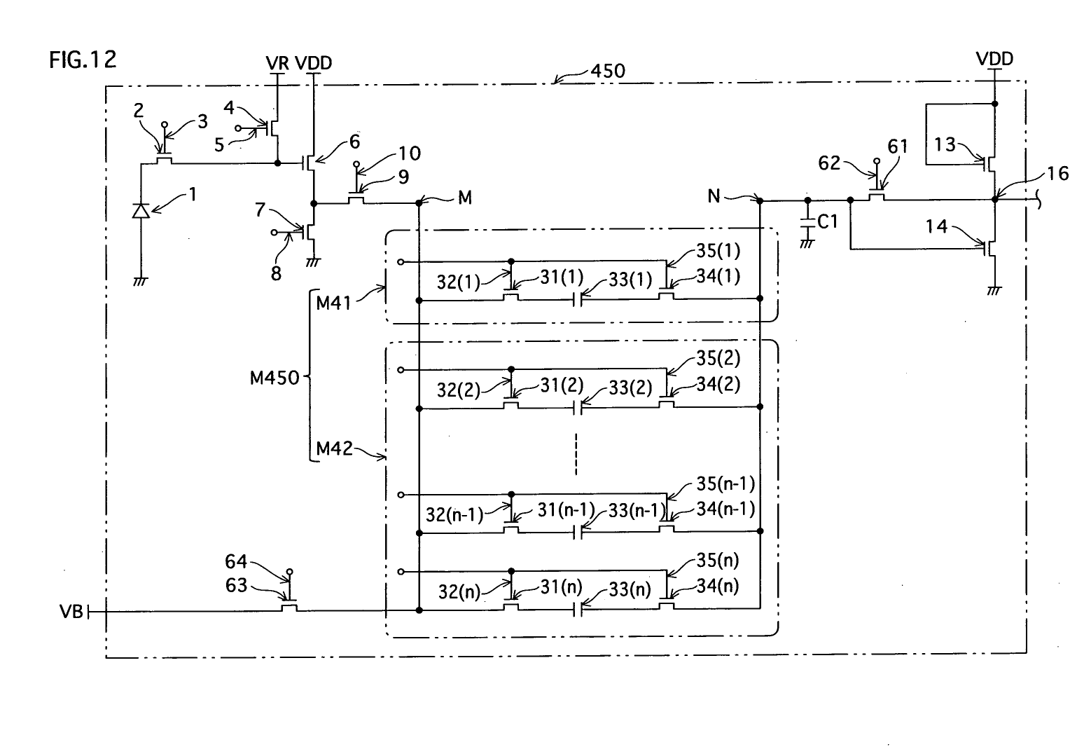

The following describes a structure of a MOS-type solid-state imaging device of a fifth embodiment with reference to FIG. 12. Note that in the MOS-type solid-state imaging device of the fifth embodiment, a structure of a storage unit M450 in an image pixel 450 is different from the image pixel 350, and other components are same as the fourth embodiment. Therefore, the explanations of other components are omitted. Also, in FIG. 12, the same symbols as in the image pixel 350 are assigned to the component parts having the same structures in the image pixel 450.

As shown in FIG. 12, in the MOS-type solid-state imaging device of the fifth embodiment, the storage unit M450 in the image pixel 450 is composed of storage groups M41 and M42. The storage group M41 is composed of two MOS transistors 31 (1) and 34 (1), and a capacitor 33 (1) On the other hand, the storage group M42 is composed of ((n−1)×2) MOS transistors 32 (2) to 32 (n) and 34 (2) to 34 (n), and (n−1) capacitors 33 (2) to 33 (n).

### 2. Drive of MOS-Type Solid-State Imaging Device

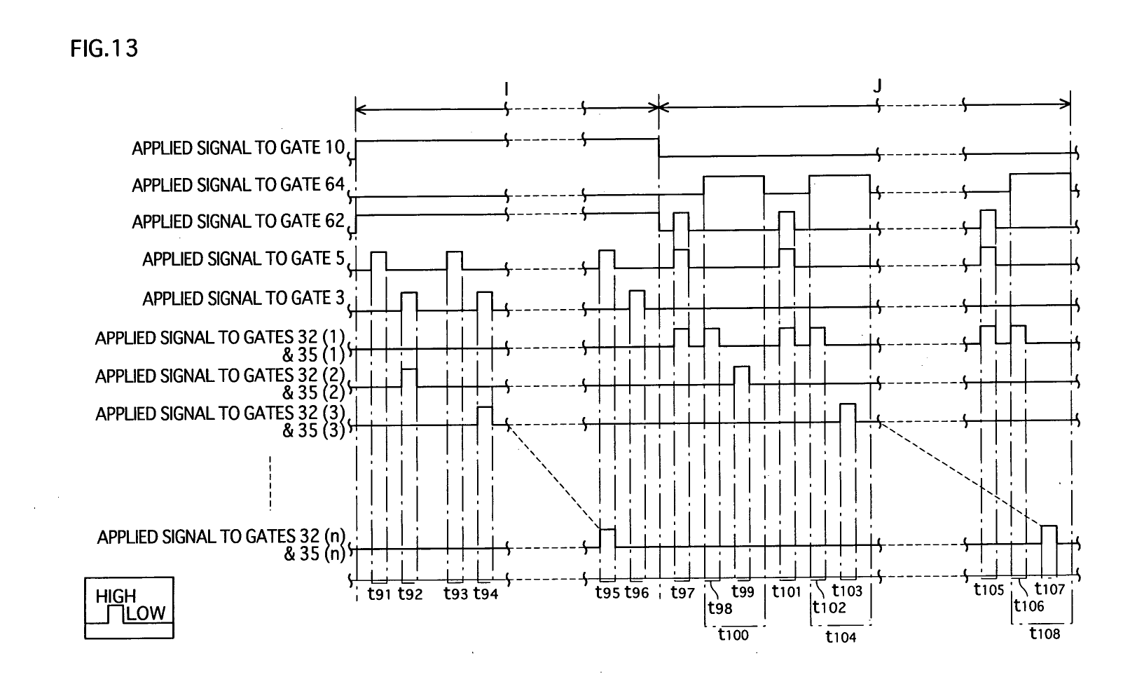

The following describes an operation of the MOS-type solid-state imaging device of the fifth embodiment with reference to FIG. 13. Note that in a timing chart shown in FIG. 13, a period for accumulating a signal (light receiving signal, noise) in the storage unit M450 is referred to as an accumulation period I, and a period for reading the signal accumulated in the storage unit M450 is referred to as a reading period J.

As shown in FIG. 13, for the accumulation period I, a high level signal is applied to the gate 10, and the MOS transistor 9 is put into the conduction state. For the reading period J, an applied signal to the gate 10 is set at a low level, and the MOS transistor 9 is put into the non-conduction state. Also, for the accumulation period I, a high level signal is applied to the gate 62, and the MOS transistor 61 is put into the conduction state.

For a period t91 for the accumulation period I, because a high level signal is applied to the gate 5, the MOS transistor 4 is put into the conduction state in addition to the MOS transistors 9 and 61. Because of this, for the period t91, the gate of the MOS transistor 6 is initialized. For a period t92, because high level signals are applied to the gates 3, 32 (2), and 35 (2), the MOS transistors 2, 32 (2), and 34 (2) are put into the conduction state in addition to the MOS transistors 9 and 61. Because of this, for the period t92, a light receiving signal (VP) corresponding to a charge generated in the light receiving element 1 is accumulated in a terminal of the capacitor 33 (2) on the MOS transistor 31 (2) side in the storage group M42 via the source follower.

A signal having an electric potential level of the output node 16 is accumulated in a terminal of the capacitor 33 (2) on the MOS transistor 34 (2) side in the storage group M42. Therefore, for the period t92, a signal having a level (VP-V16) is accumulated in the capacitor 33 (2).

In the same manner as this, for periods t93 to t95, the gate of the MOS transistor 6 is initialized, and for periods t94 to t96, the signal having (VP-V16) level is accumulated in each of the capacitors 33 (3) to 33 (n) in the storage group M42.

Next, for a period t97 for the reading period J, because high level signals are applied to the gates 62, 5, 32 (1), and 35 (1), the MOS transistors 61, 4, 31 (1), and 34 (1) are put into the conduction state. Because of this, for the period t97, a signal having an initial level (VR) is accumulated in a terminal of the capacitor 33 (1) on the MOS transistor 31 (1) side in the storage group M41 via the source follower. Also, a signal having an electric potential level of the output node 16 is accumulated in a terminal of the capacitor 33 (1) on the MOS transistor 34 (1) side.

As shown in FIG. 13, for a period t98, because high level signals are applied to the gates 32 (1) and 35 (1), the MOS transistors 31 (1) and 34 (1) are put into the conduction state. Also, for a period t100 including the period t98, because a high level signal is applied to the gate 64, the MOS transistor 63 is also put into the conduction state. Because of this, for the period t98, an electric potential level of the connection point M is set at the electric potential VB, and the signal held in the capacitor 33 (1) is outputted from the terminal on the MOS transistor 34 (1) side to the connection point N. In other words, for the period t98, a signal having a level (VR-V16-VB) is outputted to the connection point N.

For a period t99, because high level signals are applied to the gates 32 (2) and 35 (2), the MOS transistors 31 (2) and 34 (2) are put into the conduction state. Also, because the period t99 is also included in the period t100, the conduction state of the MOS transistor 63 is maintained for the period t99. Because of this, for the period t99, an electric potential level of the connection point M is set at the electric potential VB, and the signal held in the capacitor 32 (2) is outputted from the terminal on the MOS transistor 34 (2) side to the connection point N. In other words, for the period t99, a signal having a level (VR-V16-VB) is outputted to the connection point N.

For periods t101 and t102, accumulation and reading of an initial level are performed on the capacitor 33 (1) again, and for a period t103, a signal of the capacitor 33 (3) is read. Hereinafter, the same operation is executed until a period t107 for which a signal of the capacitor 33 (n) is read.

### 3. Advantage

As mentioned above, in the MOS-type solid-state imaging device of the fifth embodiment, a process of obtaining a difference between both output signals can be performed at a high speed of equal to or larger than 10000 frame rates in the noise-canceling circuits 53 (1) to 53 (L), and a high quality image signal whose noise is canceled can be outputted. Therefore, in the MOS-type solid-state imaging device of the fifth embodiment, even when the number of capacitors for each image pixel 450 is same as in the image pixel 350 of the fourth embodiment, high-speed photographing of an image with high quality and less noise can be realized by (n−1) frames which are more than the MOS-type solid-state imaging devices of the fourth embodiment. Note that since the MOS-type solid-state imaging device is adopted in the fifth embodiment, the present invention has an advantage of suppressing an increase of electric power consumption more than the conventional technology which adopts a CCD-type solid-state imaging device. This advantage is same as the first to fourth embodiments.

Also, if the MOS-type solid-state imaging device of the fifth embodiment is applied as an image device of a camera, the MOS-type solid-state imaging device has an advantage that high-speed photographing of an image with high quality can be realized while suppressing an increase of electric power consumption.

Note that although the structure in which the image pixel 450 includes an amplifier composed of the MOS transistors 6 and 7 is applied in the fifth embodiment as an example, the same effect can be obtained if a structure without the amplifier is applied. Also, in the MOS-type solid-state imaging device of the fifth embodiment, the storage unit M450 in the image pixel 450 is composed of the storage group M41 including the capacitor 33 (1) and the storage group M42 including the (n−1) capacitors 33 (2) to 33 (n). However, the number of the storage groups in the storage unit M450, the number of the capacitors 33 (1), and 33 (2) to 33 (n) in the storage groups M41 and M42; and the arrangement are not limited to these.

### Sixth Embodiment

### 1. Structure of MOS-Type Solid-State Imaging Device

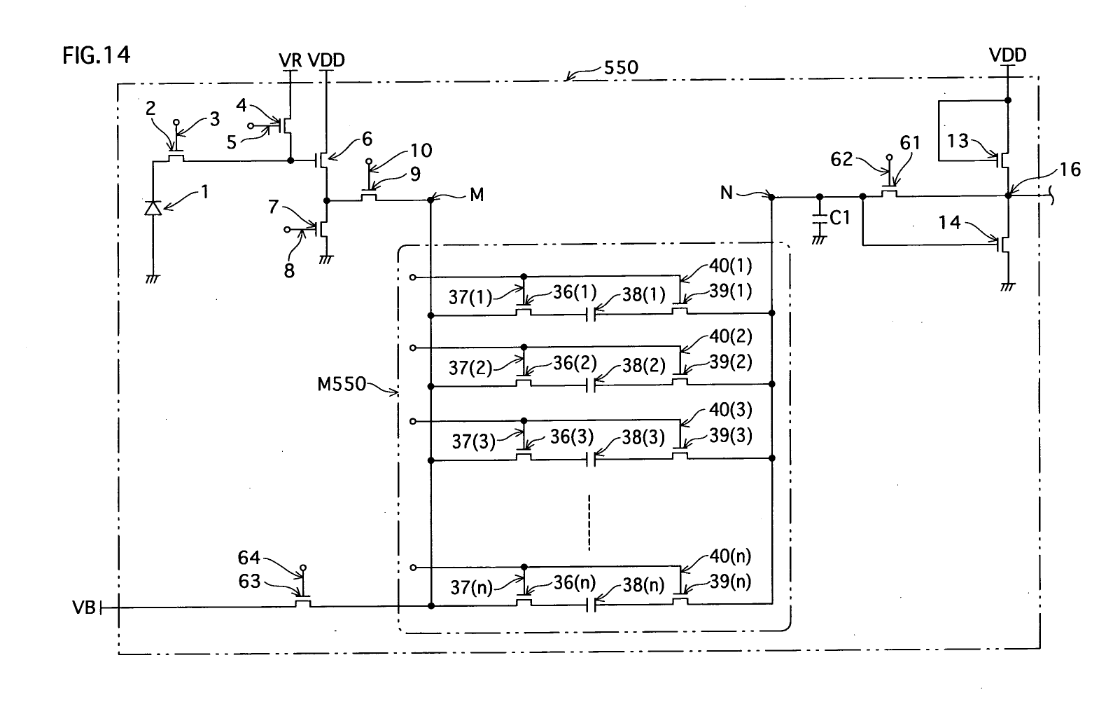

The following describes a structure of a MOS-type solid-state imaging device of a sixth embodiment with reference to FIG. 14. Note that in the MOS-type solid-state imaging device of the sixth embodiment, a structure of a storage unit M550 in an image pixel 550 is different from the MOS-type solid-state imaging device of the fourth and fifth embodiments, and other components are same as the fourth and fifth embodiments. Therefore, the explanations of other components are omitted. Also, in FIG. 14, the same symbols as in the image pixels 350 and 450 are assigned to the component parts having the same structures in the image pixel 550.

As shown in FIG. 14, in the MOS-type solid-state imaging device of the sixth embodiment, the storage unit M550 in the image pixel 550 is composed of (n×2) MOS transistors 36 (1) to 36 (n) and 39 (1) to 39 (n), and n capacitors 38 (1) to 38 (n). Also, the storage group is not divided unlike the fourth and fifth embodiments. In other words, in the MOS-type solid-state imaging device of the sixth embodiment, the n capacitors 38 (1) to 38 (n) in the storage unit M550 are shared as a noise accumulating capacitor and a light receiving signal accumulating capacitor in the image pixel 550 in a state of being temporally separated.

### 2. Drive

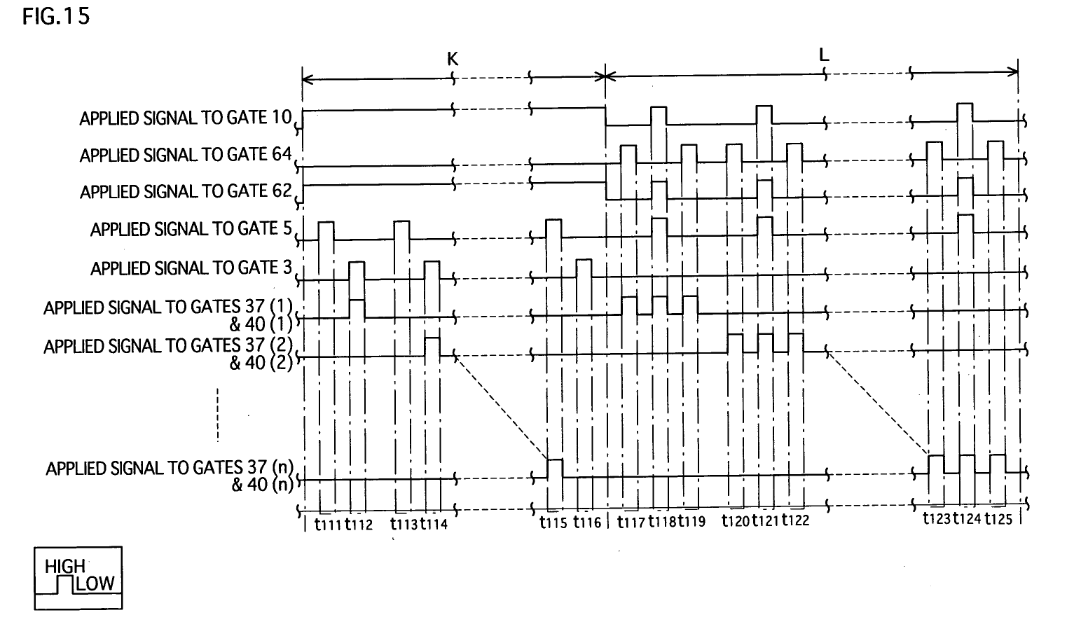

The following describes an operation of the MOS-type solid-state imaging device of the sixth embodiment with reference to FIG. 15. Note that in a timing chart shown in FIG. 15, a period for accumulating a signal (light receiving signal, noise) in the storage unit M550 is referred to as an accumulation period K, and a period for reading the signal accumulated in the storage unit M550 is referred to as a reading period L.

As shown in FIG. 15, for the accumulation period K, high level signals are applied to the gates 10 and 62, and the MOS transistors 9 and 61 are put into the conduction state.

As shown in FIG. 15, for a period t111 for the accumulation period K, because a high level signal is applied to the gate 5, the MOS transistor 4 is put into the conduction state in addition to the MOS transistors 9 and 61. Because of this, for the period till, the gate of the MOS transistor 6 is initialized. For a period t112, because high level signals are applied to the gates 3′, 37 (1), and 40 (1), the MOS transistors 2, 36 (1), and 39 (1) are put into the conduction state in addition to the MOS transistors 9 and 61. Because of this, for the period t112, a light receiving signal (VP) corresponding to a charge generated in the light receiving element 1 is accumulated in a terminal of the capacitor 38 (1) on the MOS transistor 36 (1) side in the storage group M550 via the source follower. Also, a signal having an electric potential level of the output node 16 is accumulated in a terminal of the capacitor 38 (1) on the MOS transistor 39 (1) side. Therefore, for the period t112, a signal having a level (VP-V16) is accumulated in the capacitor 38 (1)

By executing the same operations, a signal having a level (VP-V16) is accumulated in each of the capacitors 38 (2) to 38 (n) until a period t116.

Next, for a period t117 for the reading period L, because high level signals are applied to the gates 64, 37 (1), and 40 (1), the MOS transistors 63, 36 (1), and 39 (1) are put into the conduction state. Because of this, for the period t117, an electric potential level of the terminal of the capacitor 38 (1) on the MOS transistor 36 (1) side is set at the electric potential VB, and a light receiving signal is read from the terminal of the capacitor 38 (1) on the MOS transistor 39 (1) side to the connection point N.

For a period t118, because high level signals are applied to the gates 10, 62, 5, 37 (1), and 40 (1), the MOS transistors 9, 61, 4, 36 (1), and 39 (1) are put into the conduction state. Because of this, for the period t118, a signal having an initial level (VR) is accumulated in the terminal of the capacitor 38 (1) on the MOS transistor 36 (1) side in the storage group M550 via the source follower. Also, a signal having an electric potential level of the output node 16 is accumulated in the terminal of the capacitor 38 (1) on the MOS transistor 39 (1) side.

For a period t119, because high level signals are applied to the gates 64, 37 (1), and 40 (1), the MOS transistors 63, 36 (1), and 39 (1) are put into the conduction state. Because of this, for the period t119, an electric potential level of the connection point M is set at the electric potential VB, and the signal having an initial level held in the capacitor 38 (1) is outputted from the terminal of the capacitor 38 (1) on the MOS transistor 39 (1) side to the connection point N. In other words, for the period t119, a signal having a level (VR-V16-VB) is outputted to the connection point N.

From a period t120 to a period t125, the same operations as in the period from the period t117 to the period t119 are performed on the capacitors 38 (2) to 38 (n) in the storage unit M550. In other words, from the period t120 to the period t125, reading a light receiving signal and an output of a signal having a level (VR-V16-VB) from the capacitors 38 (2) to 38 (n) to the connection point N are sequentially repeated in a state of being temporally separated.

### 3. Advantage

As mentioned above, in the MOS-type solid-state imaging device of the sixth embodiment, the n capacitors 38 (1) to 38 (n) are provided in the storage unit M550 of the image pixel 550, and the light receiving signal and the noise can be stored and read in a state of being temporally separated. Therefore, in the MOS-type solid-state imaging device of the sixth embodiment, the same number of light receiving signals and noise as the capacitors 38 (1) to 38 (n) provided in the storage unit M550 of the image pixel 550 can be accumulated, and a high quality output signal with less noise can be obtained at high speed using a compact structure.

In the MOS-type solid-state imaging device of the sixth embodiment characterized by the above-mentioned structure, a process of obtaining a difference between both output signals can be performed at a high speed of equal to or larger than 10000 frame rates in the noise-canceling circuits 53 (1) to 53 (L), and a high quality image signal whose noise is canceled can be outputted. Therefore, in the MOS-type solid-state imaging device of the sixth embodiment, even when the number of capacitors for each image pixel 550 is same as in the image pixels 350 and 450 of the fourth and fifth embodiments, high-speed photographing of an image with high quality and less noise can be realized by n frames which are more than the MOS-type solid-state imaging devices of the fourth and fifth embodiments.

Also, if the MOS-type solid-state imaging device of the sixth embodiment is applied as an image device of a camera, the MOS-type solid-state imaging device has an advantage that high-speed photographing of an image with high quality can be realized while suppressing an increase of electric power consumption.

Note that although the structure in which the image pixel 550 includes an amplifier composed of the MOS transistors 6 and 7 is applied in the sixth embodiment as an example, the same effect can be obtained if a structure without the amplifier is applied. Also, in the MOS-type solid-state imaging device of the sixth embodiment, the storage unit M550 in the image pixel 550 is composed of the n capacitors 38 (1) to 38 (n). However, the number of the capacitors in the storage unit M550 and the arrangement are not limited to these.

(Supplement)

In the above-mentioned first to sixth embodiments, the MOS-type solid-state imaging device having the structure in which (L×M) image pixels are arranged in a matrix is adopted as an example. However, in the MOS-type solid-state imaging device of the present invention, the arrangement of the image pixels is not limited to the matrix shape. For example, a structure in which a plurality of image pixels are arranged in a straight line or in a curved line may be adopted.

Also, it is possible to make an appropriate change to the circuit structures in the image pixels 50 to 550 and the like which are adopted in the above-mentioned first to sixth embodiments.

What is claimed is:

1. A solid-state imaging device including an image area that is composed of a plurality of image pixels, the solid-state imaging device comprising:
a light receiving unit that is formed in the image area in correspondence with each of the plurality of image pixels, and generates a light receiving signal corresponding to an intensity of received light;
a storage unit that is arranged in correspondence with each of the plurality of image pixels, and includes a plurality of storage areas; and
a switching unit that has one end connected to the light receiving unit, and an other end connected to the storage unit via a signal readout path, wherein
the switching unit repeats an opening and closing operation during driving,
a plurality of first signals and one or more second signals are accumulated in the plurality of storage areas in the storage unit, the plurality of first signals each corresponding to the light receiving signal that is transmitted from the light receiving unit each time the switching unit is in a closed state, and each of the one or more second signals being a voltage of the signal readout path when the switching unit is in an open state, and
each of the one or more second signals in the storage unit is in a state of being physically or temporally separated from each of the plurality of first signals.

2. The solid-state imaging device of claim 1, wherein
the storage unit is connected to one end of a signal transmission path that transmits the plurality of first signals and the one or more second signals, and
a difference circuit unit that obtains a difference between each of the plurality of first signals and each of the one or more second signals is connected to an other end of the signal transmission path.

3. The solid-state imaging device of claim 2, wherein
each of the plurality of storage areas in the storage unit has a capacitor, and
the signal readout path and the signal transmission path are connected to one pole of each of a plurality of capacitors.

4. The solid-state imaging device of claim 2, wherein
each of the plurality of storage areas in the storage unit has a capacitor, and
the signal readout path is connected to one pole of each of a plurality of capacitors, and the signal transmission path is connected to another pole of each of the plurality of capacitors.

5. The solid-state imaging device of claim 2, wherein
a selecting unit that switches connection/disconnection between the storage unit and the difference circuit unit is provided in the signal transmission path.

6. The solid-state imaging device of claim 1, wherein
a number of the second signals is same as a number of the plurality of first signals,
the plurality of storage areas are divided into two groups, each includes a same number of storage areas,
the plurality of first signals are accumulated in one of the two groups, and the plurality of second signals are accumulated in the other group, and
one of the storage areas in which each of the plurality of first signals is accumulated and one of the storage areas in which each of the plurality of second signals is accumulated make a pair.

7. The solid-state imaging device of claim 1, wherein
the plurality of storage areas are divided into a first group for accumulating the plurality of first signals and a second group for accumulating the one or more second signals, and
a number of storage areas included in the second group is one or more, and is smaller than a number of storage areas included in the first group.

8. The solid-state imaging device of claim 1, wherein
each of the one or more second signals in the storage unit is in a state of being temporally separated from each of the plurality of first signals, and
each of the one or more second signals is accumulated after each of the plurality of first signals is accumulated and read out during driving.

9. The solid-state imaging device of claim 1, wherein
an amplifying unit that amplifies each of the plurality of first signals and each of the one or more second signals is inserted in the signal readout path.

10. The solid-state imaging device of claim 1, wherein
an initializing function unit that initializes a signal accumulation state in each of the plurality of storage areas is connected to the storage unit.

11. A camera having a solid-state imaging device including an image area that is composed of a plurality of image pixels, the solid-state imaging device comprising:
a light receiving unit that is formed in the image area in correspondence with each of the plurality of image pixels, and generates a light receiving signal corresponding to an intensity of received light;
a storage unit that is arranged in correspondence with each of the plurality of image pixels, and includes a plurality of storage areas; and
a switching unit that has one end connected to the light receiving unit, and an other end connected to the storage unit via a signal readout path, wherein
the switching unit repeats an opening and closing operation during driving,
a plurality of first signals and one or more second signals are accumulated in the plurality of storage areas in the storage unit, the plurality of first signals each corresponding to the light receiving signal that is transmitted from the light receiving unit each time the switching unit is in a closed state, and each of the one or more second signals being a voltage of the signal readout path when the switching unit is in an open state, and
each of the one or more second signals in the storage unit is in a state of being physically or temporally separated from each of the plurality of first signals.
